(19) United States
(12) Patent Application Publication
(10) Pub. No.: US 2026/0320078 A1
(43) Pub. Date: Oct. 15, 2026

(54) INTEGRATED PHENOTYPE REFERENCE MODEL

(71) Applicant: The Government of the United States of America, as represented by the Secretary of Homeland Security, Washington, DC (US)

(72) Inventor: Thomas Wilkinson, Avenue, MD (US)

(73) Assignee: The Government of the United States of America, as represented by the Secretary of Homeland Security, Washington, DC (US)

(21) Appl. No.: 19/459,385

(22) Filed: Jan. 26, 2026

Related U.S. Application Data
(60) Provisional application No. 63/749,292, filed on Jan. 24, 2025.

(51) Int. Cl. G06F 16/28; G06F 16/2458; G06F 16/93

(52) U.S. Cl. CPC G06F 16/285; G06F 16/2468; G06F 16/93

(57) ABSTRACT

The present invention relates to a computer-implemented system that constructs and maintains an integrated reference model using one or more processors, one or more memory devices operably coupled to the processors, and a database storing a plurality of documents, where each document associated with a document unique identifier (DUI). A concept extraction module is configured to process each document to identify a plurality of concepts, assign a concept unique identifier (CUI) to each identified concept, and associate each concept with contextual attributes as metadata. A network construction module is configured to generate a network of concept nodes, where each node corresponding to a CUI. Thew network construction module generates edges between concept nodes based on co-occurrence of concepts within documents. Each edge assigned an edge unique identifier (EUI) and a weight based on frequency of co-occurrence of the identified concepts in a document. A query processing module is configured to receive a user query comprising one or more concepts associated with concept nodes and traverse the network to identify related concept nodes and clusters using at least one clustering or path-finding algorithm. The query processing module outputs a response comprising data relevant to the query, including concept nodes not explicitly included in the query. The system is configured to incrementally update the network in real time as new documents are processed, and to allow user editing of concept nodes, edges, and metadata via create, read, update, and delete (CRUD) operations.

### STATEMENT OF GOVERNMENT INTEREST

The present invention was made by employees of the United States Department of Homeland Security in the performance of their official duties.

### BACKGROUND OF THE INVENTION

In traditional knowledge systems, concepts related to various topics in fields such as academic medicine and biology are often organized hierarchically. For example, in the Linnaean classification in biology or in medical ontologies like SNOMED, concepts are arranged in a tree-shaped hierarchy of types and subtypes (e.g., diabetes as a subtype of pancreatic disorders). Moreover, conventional knowledge systems typically operate within a single domain or ontology. Often, these systems focus on individual data elements or require direct interoperability between similar datasets to map groups of concepts, which may not be sufficient for solving complex problems in practice.

While hierarchical systems are the standard for teaching and organizing knowledge, they do not reflect how practitioners think or work in real-world settings. Instead, practitioners move laterally across concepts that are practically related, rather than strictly following hierarchical parent-child relationships. Thus, hierarchical systems are useful for structured classification but insufficient for capturing the lateral, real-world relationships needed in practice.

Thus, knowledge systems can benefit from integrating, mapping, and interpreting disparate datasets and concepts across domains and systems, thereby facilitating interoperability and thematic clustering across domains by grouping documents or entities based on shared concepts to reveal underlying patterns or pathways between them.

### SUMMARY OF THE INVENTION

Briefly, according to the present invention a computer-implemented system constructs and maintains an integrated reference model using one or more processors; one or more memory devices operably coupled to the processors; and a database storing a plurality of documents, each document associated with a document unique identifier (DUI). A concept extraction module is configured to process each document to identify a plurality of concepts, assign a concept unique identifier (CUI) to each identified concept, and associate each concept with contextual attributes as metadata. A network construction module is configured to generate a network of concept nodes, where each node corresponding to a CUI. Thew network construction module generates edges between concept nodes based on co-occurrence of concepts within documents. Each edge assigned an edge unique identifier (EUI) and a weight based on frequency of co-occurrence of the identified concepts in a document. A query processing module is configured to receive a user query comprising one or more concepts associated with concept nodes and traverse the network to identify related concept nodes and clusters using at least one clustering or path-finding algorithm. The query processing module outputs a response comprising data relevant to the query, including concept nodes not explicitly included in the query. The system is configured to incrementally update the network in real time as new documents are processed, and to allow user editing of concept nodes, edges, and metadata via create, read, update, and delete (CRUD) operations.

### BRIEF DESCRIPTION OF THE DRAWING

FIG. 1 shows a diagram comparing the ontological and phenotypic views.

FIG. 2 shows an IPRM network that maps data from disparate information systems.

FIG. 3 shows a block diagram of the cloud-based implementation of the IPRM system.

FIG. 4 shows an example relationship of the unique identifiers used to access a specific element within the IPRM system.

FIG. 5 shows a data flow diagram within the IPRM platform.

FIG. 6 shows a weight table for the children's literature example.

FIG. 7 shows a graph of the power-law reduction in the search space.

FIG. 8A shows various medical concepts with hypothetical numerical values as vector dimensions.

FIG. 8B shows the cosine computed for any two concepts shown in FIG. 8A.

FIG. 9 shows a diagram of clustering based on numerical attribute adjacency.

FIG. 10 shows an example of co-occurrence within a set of documents.

FIG. 11 shows an IPRM network with patient symptom concepts and edges indicating the number of co-occurrences between concept nodes.

FIG. 12 shows a visual representation of weighted connections and the centrality of concept nodes.

FIG. 13 shows a diagram that rearranges the patient symptom concept nodes to depict the incremental expansion of the reference model.

FIG. 14 shows the expansion of the reference diagram with the addition of diagnosis concept nodes, which co-occurred with the patient symptom concept nodes.

FIG. 15 shows the expansion of the reference diagram with the addition of medication concept nodes, which co-occurred with the patient diagnosis concept nodes.

FIG. 16 shows an expansion of the reference diagram by adding other diagnostic concept nodes that co-occurred with the diagnostic concept nodes and by adding lab and study concept nodes that co-occurred with the diagnostic concept nodes.

FIG. 17 shows an expansion of the reference diagram with the addition of procedure concept nodes that co-occurred with lab and study concept nodes.

FIG. 18 shows an expansion of the reference diagram with the addition of consult concept nodes that co-occurred with the procedure concept nodes.

FIG. 19 shows the reference diagram with vertical columns indicating the type of concept metadata associated with each node.

FIG. 20 shows the reference diagram with additional metadata associated with each node, including where in the diagram concept nodes are located and which ontologies they might be indexed to.

FIG. 21 shows the reference diagram with concept nodes associated with valence attributes (such as rising, falling, presence, or absence) or other contextual attributes (such as personal or family history) of a particular document.

FIG. 22 shows how the IPRM system aligns information design with the cognitive processes in medicine to create a direct correspondence between the knowledge representation and how the knowledge is used.

### DETAILED DESCRIPTION OF THE INVENTION

### 1. Overview

The present invention is embodied in an Integrated Phenotype Reference Model (IPRM), which maps practical knowledge-how things work together-across documents and domains to create a dynamic, practical, and interoperable knowledge representation system. This knowledge system can be machine-learned and human-augmented to support intuitive exploration and integration across diverse domains and datasets. Consequently, the IPRM is both human- and machine-readable and editable, and it can be incrementally updated to tailor a network of concepts for novel or idiosyncratic circumstances.

The structure, methods, and operational features of the IPRM are implemented by a computational system and a data system, which are integrated to capture evolving knowledge. The computational system is integrated with a system for managing and integrating knowledge and data. This integrated system is hereinafter referred to as the IPRM system, which enables interaction with users for editing and making queries to gain insight from the data system. The data system embodies a reference model that organizes knowledge as networks of relationships among concepts from multiple domains or disciplines, where each concept is treated as a node and each relationship between two concept nodes is treated as an edge. Each metaphysical network of concept nodes and edges is referred to as an IPRM network.

Unlike traditional manual mapping, which is tedious and prone to combinatorial complexity as more datasets are added, mapping datasets to the IPRM networks allows multiple datasets to share data without requiring pairwise mapping, streamlining data integration and cleaning processes. On the other hand, the IPRM system supports incremental updates and tailored modifications for novel or idiosyncratic circumstances, which conventional systems typically lack. The IPRM system can be used to traverse each IPRM network to gain knowledge about relationships between concepts, documents, datasets, events, populations, and so on. The IPRM system makes the IPRM networks editable by users and machines without causing non-linear ripple effects and is immediately adaptive to new information.

An important feature of the IPRM system captures practical knowledge by bridging disparate ecosystems of concepts within datasets rather than relying on theoretical or pedagogical classifications. For example, the IPRM system can also bridge orthogonal datasets and reveal connections between distant clusters of concepts, supporting broader comparisons and enabling the identification of unknown relationships, thereby enhancing the utility of conventional knowledge systems in fields such as healthcare, law enforcement, and engineering. This approach allows for the clustering of related concepts and the identification of connections between seemingly distant concepts. In an exemplary configuration, the user of the IPRM system submits a query and data relevant to multiple concepts. The IPRM system returns data, optionally in natural language, responsive to the query, containing data about concepts relevant to the query but not in the query itself. For example, the query can ask “Is there a linkage of context between people with lung cancer, emphysema, and reduced cardio performance?” The IPRM system can respond by stating “Individuals who use tobacco products have an increased probability of developing these diagnoses.”

### 2. The IPRM Architecture

The IPRM system can be implemented on cloud servers or on-premises private servers, for example, within federal government or interagency computing environments. Computing resources used in both implementations of the IPRM system can include data processors constructed with hardware, software, firmware, or a combination of these, including central processing units (CPUs), graphics processing units (GPUs), tensor processors, hardware accelerators, field-programmable gate arrays (FPGAs), application-specific integrated circuits (ASICs), virtual machines, containerized compute concepts, distributed computing clusters, or serverless compute functions. As used herein, data processors refer to any computing components-physical, virtual, or cloud-based-designed to run instructions, perform computations, manipulate or transform data, or execute numerical, logical, statistical, analytical, probabilistic, modeling, machine learning, or pattern recognition functions. The IPRM networks can be implemented physically by a database layer comprising relational and NoSQL databases, which are accessible to cloud or private servers of the IPRM system through a network layer that provides connectivity for storing and retrieving data from the databases. A security layer comprising firewalls and security groups provides authentication and data protection for the IPRM.

### 3. Phenotype

Broadly, a phenotype, in the context of the present invention, is the characterization of the traits of something as they are manifest in the world. In biology, a phenotype refers to observable traits of an individual, such as hair color, eye color, and skin tone, which are distinct from the underlying genetic basis (genotype). In medical informatics, phenotype most commonly refers to the characterization of a patient, such as “a male over 50 with no history of heart disease.” In the IPRM, phenotyping means the characterization and contextualization of concepts as they occur in and across domains. In one embodiment of the present invention, phenotyping is achieved by dynamically characterizing and contextualizing concepts as they co-occur across documents.

### 4. Co-Occurrence

Co-occurrence in the context of the present invention refers to the mention of two or more concepts, such as “diabetes” and “metformin,” together in the same document, regardless of how many times each concept is mentioned. For each document, the IPRM system records every possible pair of unique concepts, and the order of the paired concepts does not matter. A concept that appears more than once within a single document is paired only once with each of the other concepts.

The IPRM system determines the relationship between two concepts computationally by counting the number of occurrences of the concepts in the same document. Each IPRM network metaphysically represents the relationship between the two concepts as an edge between the two concept nodes. That is, the IPRM system records each pairing of concept nodes as a co-occurrence linked with an edge, where the number of co-occurrences reflects the strength of the edge or relationship between the paired concepts. Thus, the strength of the edges between any two concept nodes is determined by how frequently they appear together in the same context, such as on the same page of a document or within the same document. This is referred to as the “weight of the connection” between two concept nodes.

For instance, the concepts of bread, peanut butter, and jelly frequently co-occur in documents about making sandwiches, even though they are categorized separately in a grocery store. As a result, phenotyping organizes concepts based on their real-world usage. Similarly, phenotyping can be used to identify patterns and connections between co-occurring diagnoses and medications. In this way, phenotyping can group medical concepts such as thyroid-related symptoms, diagnoses, and treatments based on their contextual relationships, reflecting their co-occurrence in clinical practice. As a result, phenotyping in the healthcare field can identify patterns of symptoms, diagnoses, and treatments based on how they are practiced, rather than theoretical categorizations. In social networks, people become nodes on the IPRM based on their mentions in documents, forming networks that reflect real-world intersections rather than explicit social media connections.

### 5. Ecosystems of Concepts

The IPRM operates within a dynamic framework for representing and relating diverse concepts in both human-understandable and machine-computable form. The IPRM system integrates metadata representing concept attributes into one or more IPRM networks and updates each over time. By computationally detecting patterns, the IPRM uncovers relationships and provides insights by traversing across diverse domains and datasets. This approach enables the identification of relationships and clusters within ecosystems of concepts that are formed based on the co-occurrence of concepts and their shared attributes, supporting applications across diverse domains.

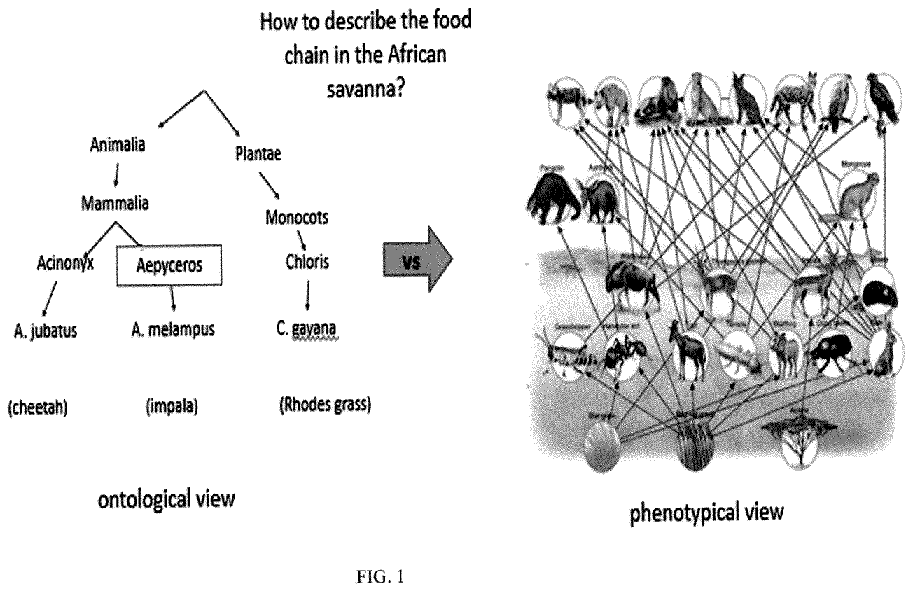

FIG. 1 shows a diagram comparing the ontological and phenotypic views of food chain concepts in the African savannah. As shown, IPRM organizes concepts and relationships as they occur “in the wild,” i.e., not as logical hierarchical relationships but as a lateral ecosystem of concepts and relationships across real-world applications. In other words, IPRM treats ecosystems of concepts phenotypically as a lateral network of concept nodes based on their associations and practical relationships, rather than just their place in a formal hierarchy or taxonomy. In this example, an IPRM network can represent tightly linked relationships such as food chains or supply chains, even when the individual links are very different (e.g., connecting cheetahs, savanna grasses, and ungulates in an ecosystem), and each concept node has corresponding attributes associated with it as metadata. This lateral IPRM network can be combined with other IPRM networks that span multiple domains, integrating metadata and attributes into the concept nodes. In this way, the IPRM system can compute relationships among concept nodes across orthogonal datasets, which is central to phenotyping. In another example, the IPRM networks can link diagnoses, laboratory tests, and medications in medicine, regardless of their hierarchical parent-child relationship.

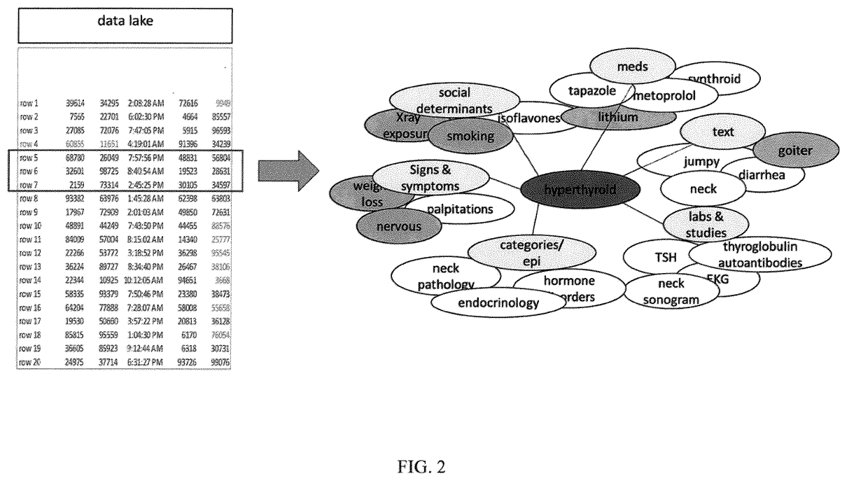

FIG. 2 shows an IPRM network that maps data from disparate information systems in a data lake to related concept nodes connected by edges that align with cognitive representations in medicine. The mapping can be to standardized concepts in medicine or any other field, as well as to local patterns, facilitating interoperability and concept-based clustering across domains, as further described below. As stated above, in IPRM networks, edges represent the computed relationships between concept nodes, reflecting how the world works in practice rather than relying solely on logical structures. This network of concept nodes and edges is dynamic, growing as new concepts and relationships are identified, often revealing previously hidden or novel connections.

### 6. Interoperability

Interoperability, which requires (at a minimum) that data be exchanged bilaterally between different applications, is usually built through a tedious process of manually mapping data elements between two systems. When two datasets span the same domain, one might reasonably conclude that their data elements could be mapped to one another. For example, two Electronic Health Record (EHR) systems should both contain patient visit notes, radiology reports, lab results, insurance information, and so on, and one would reasonably expect that porting a patient's record from one of those systems to the other would be straightforward, since they contain the same kinds of data. The reality is quite different, as the system architectures are often quite different, so the way their respective data are stored is quite different.

For example, one system may capture a patient's name as a single field, combining first and last names, whereas another might have first, middle initial, and last names as separate fields. Continuing with names, one system may have a field for Nickname, another may call the same thing Informal Name, another might capture it as a free-text note, and yet another may not capture this data at all. Other data continue to expand the differences: one system may store external documents as PDFs, another as bitmaps, and yet another may post them in their original formats to an online repository in the cloud. It quickly becomes more complicated from there: EHRs often have thousands of tables with varying degrees of redundancy, normalization, indexing, load-balancing features, coding requirements, and more. The IPRM directly supports data mapping, but it also extends interoperability to possibilities that can add context and nuance to manual mapping, as well as creating entirely new ways of interoperating.

### 7. Domain

A domain represents a category or field of knowledge, such as healthcare, law enforcement, food, or any other area where concepts and documents are relevant. Domains help organize and index concepts, documents, and sections used in the present invention, enabling efficient aggregation of same-domain information or purposeful searches across domains.

### 8. Document

In the IPRM, the constructed phenotypes are document-centric, meaning that the pattern of attributes describes a document. It is essentially a complete unit of thought that contains narrated thinking or an interpretation of data. The document serves as the transactional unit for computing relationships between node concepts. The advantage of using documents is the reduced likelihood that extracted concepts will be taken out of context.

Among professional documents, a signature is usually what denotes a document as a complete thought. In medicine, records of patient visits with providers, lab results, and radiology reports are all signed documents and would be appropriate transactions for an IPRM reference model, despite their variable lengths, structures, and content. Likewise, in law enforcement, incident reports, witness statements, arrest reports, evidence logs, and similar documents would also be transactional for an IPRM. In academia, a white paper with author attributions would be an appropriate document for an IPRM; in news media, any article with a byline would be appropriate.

In non-professional or unsigned documents, the boundaries of what constitutes a useful unit may require some judgment, but they will no doubt be discernible from the document content and structure. Some additional example documents appropriate for an IPRM are listed below.

In the illustrative examples above, the necessary documents might arise from a variety of sources, and all may be accommodated, including those with very limited data and even documents with multimodal content, as long as the salient concepts can be extracted. For the ingredients example, IPRM concepts might be extracted from documents about children's lunches or, more generally, from recipes. Likewise, documents about how to assemble or build things would convey information about hardware and needed tools, and some examples might also provide co-occurrences with other methods of accomplishing the same essential construction task. Documents such as research papers and wiki texts on animals and their behaviors would rapidly build an IPRM about the ecosystem within which those animals live. And documents such as books and stories can easily be used to construct an IPRM of related concepts from any domain, based on the words themselves, limited only by the subjects covered in the books.

Documents, especially those built on narrative, naturally bridge disparate domains. That is to say, it is common in everyday discourse to talk about things from different disciplines without giving it a second thought. We might talk about getting an apple and cutting it with a paring knife, despite the significant differences between fruit and cutlery.

This feature of documents becomes very useful in more complex webs of information. For example, imagine the local newspaper writes a story (a document appropriate for use in the IPRM system) that mentions a new fentanyl analogue. The article also names a cartel that the police suspect is supplying the drug and the local neighborhood where the drug was found. Meanwhile, hospital documents include metadata about the hospital's location, and those attributes can connect the geography mentioned in the article to the hospital's service area. Many hospital patient documents will co-occur with fentanyl and its antidote, Narcan; and the hospital pharmacy's inventory documents might report that the Narcan supply is currently running low. With just a few hospital documents and a single newspaper article, the resulting reference model will capture significant connections between the low inventory of Narcan at a specific hospital (medical and supply chain domains) and the activity of a cartel in another country (law enforcement and national security domains). These kinds of connections are a cornerstone of preparedness for and response to emergencies.

### 9. Document Attributes

Any document processed in the IPRM system is assigned a Document Unique Identifier (DUI). The DUI, along with all unique identifiers used in the IPRM system, is a unique identification string that is sufficiently long or complex to accommodate every identifier the IPRM system needs, now and into the future. For example, a DUI might be an 18-digit number with no decimal point and leading zeroes suppressed, such as the identifiers used for SNOMED, or it could be a 128-bit alphanumeric string, which is complex enough to generate a unique identifier every second for the next 9 quintillion years. The latter is known as a Globally Unique Identifier, or GUID.

Additional attributes (metadata) associated with the document are then indexed to that DUI. Document attributes might include the people associated with the document (patients, providers, authors, anyone mentioned or cited, etc.), any dates associated (date of creation, date of service, date of observation, date of signature, date of publication, etc.), any geographic references (location of service, locations mentioned, etc.), and other attributes deemed relevant. Some attributes might be unique to one document and no other, but they might still be worthy of capturing as descriptors for the document.

Most documents are composed of subparts, headings, or other sections, many of which may be named (such as the chief complaint or past medical history sections in a medical record, or the abstract or conclusion sections in an academic paper, etc.). Any document sections that are useful for the context of the extracted concept nodes, whether named or not, are assigned Section Unique Identifiers (SUIs) as attributes of the parent DUI. Due to traceability requirements, SUIs are unique to their parent document and are not reused for other documents. They can represent any meaningful area or part of the parent document. When the section is specifically named, a Type Unique Identifier (TUI) is added as an attribute to the SUI itself. TUIs are reusable across documents and sections and are attributes of concept nodes as well. TUIs create a simple taxonomy of IPRM elements.

As with sections, documents can have TUIs attached as attributes. Categories such as the document's domain or purpose (such as a patient visit record or lab report in healthcare, an incident report in law enforcement, or a recipe in food) can be captured by TUIs. TUIs are reusable across documents and are used to aggregate same-domain information, or conversely, to purposefully search for nodes in different domains, which is particularly useful if you're looking for something that's unusual or missing. If there is a need to index a section or document (or node) with more complex types and subtypes, rather than using a simple TUI taxonomy, it's best to relate the IPRM elements to a formal reference ontology instead, such as the W3C's “Simple Knowledge Organization System.”

Although document attributes might be explicitly listed in one-to-many relational tables, indexed to the DUI, those attributes that are amenable are better represented as nodes within the IPRM itself, alongside the DUIs themselves. The attributes are then connected to the DUI nodes as edges. Since the weight of an edge is a calculated number equal to the total number of occurrences, the weight of connections between a DUI and its SUIs would normally be 1; other attribute weights would likewise normally be 1, although some might vary according to context.

To integrate attributes into the IPRM system, the DUI, SUI, and TUI indexing systems must be compatible (interchangeable) with the Concept Unique Identifiers (CUIs) described in more detail below. In this way, documents, sections, and taxonomic categories can become concepts on the network as well.

Generally, each edge between any two concept nodes in the IPRM system must be traceable to its source DUI and, if available, to the SUI, for at least three reasons: 1) to create an audit trail, 2) to allow the reassembly of a document's main concepts, and 3) to aggregate documents into sets.

### 10. Concept

A concept is a relevant item identified, labeled, and recorded within a document. Concepts can be found in free text or discrete data elements. For example, the IPRM system might process concepts from medicine, law enforcement, and natural disasters within the same cluster of relationships gleaned from various documents across different domains, enabling computable relationships across otherwise orthogonal or seemingly unrelated datasets. Concepts may be introduced extemporaneously into the model, or existing concepts may be augmented with locally relevant attributes and context.

When a concept is identified and extracted from a document, it is assigned a Concept Unique Identifier (CUI), making it available as a node in the IPRM system. If the concept is already represented in the IPRM, the CUI maps to an existing identifier. Otherwise, a new CUI is assigned if the concept is being added for the first time. Once the CUI is assigned, contextual attributes are associated with the node as metadata.

### 11. Nodes

As stated above, each IPRM network is a set of nodes, each representing a distinct concept. Nodes have many attributes of several kinds, including the DUIs and SUIs mentioned above, which record where the concept and its relationships were originally captured. Since concepts are categorical, they repeat, so the same concept will be extracted from many documents; therefore, most nodes will have multiple DUI and SUI attributes.

A node has a preferred name for the concept it represents, but the concept may also have synonyms, abbreviations, alternative spellings, and possibly common misspellings attached as attributes. As with DUIs and SUIs, a node usually has one or more TUIs associated with it, indicating the types or taxonomies to which the node belongs. For example, in medicine, a node might be connected to TUI attributes such as a patient, a diagnosis, a medication, a laboratory study, a radiographic image, or other types of medical data.

The IPRM system maps concept nodes to their corresponding concepts in one or more ontologies, producing a cross-reference for all the same concepts. For example, the medication metformin has the SNOMED CT code 372567009, a UMLS code of C0025598, and a PubChem code of 4091. More specifically, the RxNORM code for the pill metformin hydrochloride 500 MG is C0978483. Similarly, the CPT code for measuring metformin in blood is FMETN75389, while the same test has a LOINC code of 55548-2. All of these codes signify metformin in different forms and contexts, with varying degrees of specificity, and they can all be connected as attributes to an IPRM node with the same meaning.

The mapping indexes the content of documents, regardless of where they arise or what their subject matter is, to standardized concepts and local patterns with defined relationships within the IPRM. Because concepts within the IPRM are cross-referenced to formal ontologies, the mapping also creates bridges to other forms of knowledge representation. As with documents, the attributes of concept nodes can usually be represented as nodes themselves, when appropriate, connected to their mother concept within the IPRM. On the other hand, some attributes, such as synonyms or references to formal ontologies, can be directly represented in each IPRM network by zero-distance (infinite-weight) connections to the mother concept, but work more simply when confined to related lists or tables instead.

### 12. Edges

Edges in each IPRM network primarily represent connections between concept nodes, but they are flexible enough to connect any two unique identifiers, including documents, sections, types, modifiers (see the next section), and, technically, even other edges. However, the usefulness of connecting two edges to each other is more limited than that of the other types of connections. As with the other unique identifiers, edges have their own Edge Unique Identifiers (EUIs).

Any edge that connects to a concept node (at one or both ends of the edge) requires two identifiers from that node: the node's CUI and the node's relevant SUI (or DUI if the SUI is unavailable or unspecified). Concept nodes themselves also carry SUI and DUI attributes, but they carry many instances of those attributes from across many documents, whereas an edge is a unique connection within a unique context. For the primary case of representing a connection between two concept nodes, an edge needs the CUIs of both concepts and the location information of where those two concepts appeared together (typically two SUIs). By contrast, when an edge connects other attributes, the location information is generally not needed.

This combination of edge attributes may be somewhat redundant at times, such as when the same DUI is listed twice if no SUIs are available for two concept nodes. However, the occasional redundancy affects only the storage of attributes without encumbering computational complexity, and the payoff is increased granularity about connections, which affords essential flexibility for the IPRM system. This includes the possibility of having two different edges to the same concept in the same document, for very different reasons. This flexibility can be important because patients routinely have multiple things going on, each with multiple contexts. While the IPRM system is not designed to fully phenotype a patient per se, it can accommodate complex relationships across concepts as they appear in the world.

For example, the medication vancomycin can be an allergy, can cause serious side effects (non-allergic), can be used as a treatment in either oral or IV forms, can be a lab test (commonly, peak and trough values are measured on either side of an IV dose, which are the same lab test but for different reasons), can be mentioned in the patient narrative as something that hasn't been tried yet (vancomycin is commonly reserved as a last choice to avoid overuse), and so on. If vancomycin is mentioned in more than one of these contexts within the same document, it would typically appear in different sections of that document, and therefore the concept node would have multiple SUIs for that document, from which different edges might emanate, providing granularity on the precise nature of its co-occurrence with other concepts.

The count of all EUIs that share the same two CUIs as attributes gives the weight of the connection between those two concept nodes. Generally, inter-nodal weights are not stored but rather computed on the fly as needed, since 1) the weights are dynamic, as new documents are incrementally added to the IPRM system, and 2) counting functions are extremely efficient and computationally trivial. The only time weight values might be stored is if a snapshot of the state of an IPRM network is needed.

### 13. Modifiers

Modifiers are contextual annotations about entities within the IPRM system. They are identified by Modifier Unique Identifiers (MUIs). Modifiers add flexibility in representing complex relationships. They are not required features of an IPRM, but can be applicable to specific use cases, such as helping to identify long causal chains, to manage mis-, dis-, or mal-information, or to create clusters built on fuzzy sets or probabilities, among other capabilities.

For example, the disease COVID-19 and the treatment ivermectin co-occur in many documents, not because ivermectin is a treatment for COVID-19, but rather because it is not an effective treatment, although considerable research was required to establish that fact. A modifier can be used to annotate the ineffectiveness of the relationship between ivermectin and COVID-19 without ignoring or suppressing the significance of the relationship itself. Without the modifier, ivermectin might be erroneously suggested as a highly ranked treatment option for COVID-19. Used in this way, it is easy to see how modifiers can be used locally to encourage an established best practice or discourage outdated or erroneous practices.

Modifiers can be highly flexible. Their attributes begin with a list of one or more unique identifiers for the elements to be annotated. These elements can include any applicable types of unique identifiers, including EUIs. A closely related attribute is a flag indicating whether the modifier's list of unique identifiers is ordered. A triplet of attributes can be associated with an MUI: first, a TUI for the type or nature of the modification itself; second, a numeric value of any kind; and third, a TUI describing how the number is to be applied. For the COVID-19 example above, the MUI would include the following attributes: the CUIs of the two concept nodes, “ivermectin” and “COVID-19”; the flag “ordered”; the TUI for “is not a treatment for”: the number 1.0; and a final TUI for “degree of certainty.”

Common modifiers might include TUIs for “negative,” “pertinent negative,” “positive,” “rising,” “falling,” “left,” “right,” “discontinued,” “increased,” “decreased,” “causes,” or—as in the example above—“is not a treatment for,” and so on. In its simplest form, the MUI applies the TUI label to its list. MUIs are not expected to be common in an IPRM; they are likely to be manually inserted and are more likely than not to be temporary features of a working IPRM. Moreover, not all MUI attributes are necessarily relevant in every modifier use case. However, the availability of a numerical value and the flexibility in how the number is applied to the modifier provide the basis for finding unusual clustering patterns, including fuzzy sets or groups with differing degrees of likelihood.

Modifiers can represent temporal, causal, and other sequenced relationships. Undirected graphs are simple because connections between nodes are scalar and require minimal computational power to store and manipulate. Each IPRM network can be represented as an undirected graph (no order is assumed between concept nodes), in part because the relationship being captured is simply a co-occurrence within a document, and in part because the nature of the relationship is often unknown and assumptions cannot be made. Despite this, the order of concepts in a relationship may be the relationship's purpose or significance, and the user may know the nature of the relationship even if processing cannot detect it. In such cases, it becomes necessary to provide simple strategies for sequences, leveraging the attributes already described above.

Modifiers can represent short sequences. Since the IPRM system enables end-user editing, the simplest way to capture a sequence in the IPRM system is to manually add a node that represents the sequence in its entirety. For example, “worsening abdominal pain” is often a critical feature of the diagnosis of acute appendicitis and could be represented as a single concept node that captures the temporal aspect of ‘worsening,’ while still connecting back to both the original symptom “abdominal pain” and the diagnosis “appendicitis.”

Extending the above example, it's common for the trend of numerical data to be relevant: a value could be rising, falling, or staying steady. Although numerical data are addressed separately below, these notions are temporal in nature, similar to ‘worsening.’ Likewise, they can be adequately captured as manually inserted nodes, such as a node representing “rising liver enzymes” as a complete concept node.

In another example, a rash (especially in children) often follows a viral infection. There's no official diagnosis for a post-viral exanthem, so “rash” is usually the diagnosis recorded in a patient's medical record, even if it doesn't convey all we know about the rash. In this case, an end-user might add “post-viral exanthem” as a concept node in the IPRM, capturing the relevant causal chain of events, and then connect that node to viral infection, rash, and the patient for added context and clarity.

In a third example, inserting a pair of concept nodes may resolve any confusion over similar words in medicine. For example, “pelvis” can refer to either the kidney or the skeleton, and “Paget's disease” can refer to either a breast malignancy or a non-malignant bone growth. These homographs can be resolved by adding two new concept nodes that clarify the differences or by mapping them to the correct locations in reference ontologies, but manually creating distinct nodes to capture simple alternatives requires less computational overhead.

So, the two nodes “renal pelvis” and “pelvic bones” might clarify those two concepts, even if the source document does not make the explicit distinction (although the context of the document, such as a note about a kidney stone vs a bone density study, usually makes it obvious to a human reader). Likewise, “Paget's disease of breast” and “Paget's disease of bone” would add clarity to the IPRM, even if the source document does not make an explicit ontological distinction between the two versions of “Paget's.”

Modifiers can represent longer sequences. Causal sequences, supply chains, cascading dependencies, and the like are longer sequences that are probably best modeled in directed graph structures or hierarchical systems, but the use of modifiers as described above allows the IPRM system to capture and connect to these sequences when they are applicable within an ecosystem of concepts. A modifier can assign a MUI to an ordered list of extant nodes and annotate the nature of their sequence, but it adds computational complexity to the IPRM system, whose simplicity lies in the nondirectional, otherwise unburdened co-occurrences of concepts. With complex sequences, especially branching trees, the better strategy is to remove their representation from the IPRM system and instead index their nodes to an appropriate formal ontology.

Modifiers can handle numerical values. Numerical data are generally not well represented as nodes in an IPRM. Most often, numbers are better characterized as attributes or characteristics of concepts rather than as concepts per se, although there are instances when numbers themselves have particular importance as concepts. The IPRM system can represent all these possible roles.

There are three ways to manage numbers in the IPRM system. The first is to instantiate one or more numbers as concept nodes. This can be useful when a specific number is important to the model. For example, Section 508 of the Rehab Act requires government information to be accessible to people with disabilities. In documents, this law is often referred to by its section number alone, as in “508 compliance.” In this case, the number 508 is categorical rather than numerical per se, and it makes sense as a standalone concept node. In a more numeric example, during the critical care management of diabetic ketoacidosis, the exact pH from a blood gas might determine the next step in care. Since human pH normally runs between 7.35 and 7.45, each of the 11 numbers from 7.35 to 7.45 (inclusive) can be instantiated as concept nodes, perhaps with 5 more numbers on either side to capture extreme values. Then each step in the critical care pathway can be linked to one or two specific values, creating the appropriate cluster of clinical activities and patient status.

The second method is to explicitly convert numbers into categories. Numerical values are often compared against a threshold or reference range, and in this regard, they can be translated into categories and installed as concept nodes in the IPRM system. For example, a patient's temperature or lab result might be categorized as normal, high, low, panic high, panic low, or simply critical. Each of these categories can be easily rendered as logical concept nodes in the IPRM system and can serve to adequately and accurately connect to their related concepts.

The third method is to leverage modifiers to add numeric values as attributes to underlying concept nodes. As described above the modifiers, this introduces a great deal of flexibility in tracking and connecting numeric data, but at the cost of increased computing requirements and some loss of the intuitive interpretability of the underlying IPRM.

### 14. Metadata

Metadata represent attributes associated with various entities in the IPRM system. Attributes are properties or identifiers associated with reference model entities (such as documents, concept nodes, modifiers, or edges) and serve as metadata within the IPRM system. These attributes include unique identifiers, synonyms, abbreviations, alternative spellings, associations with formal ontologies, taxonomic types, flags indicating order, numerical values, and contextual information such as document location or the nature of a modification. The pattern of these attributes collectively characterizes an entity and its relationships within the IPRM system.

### 15. IPRM Implementation

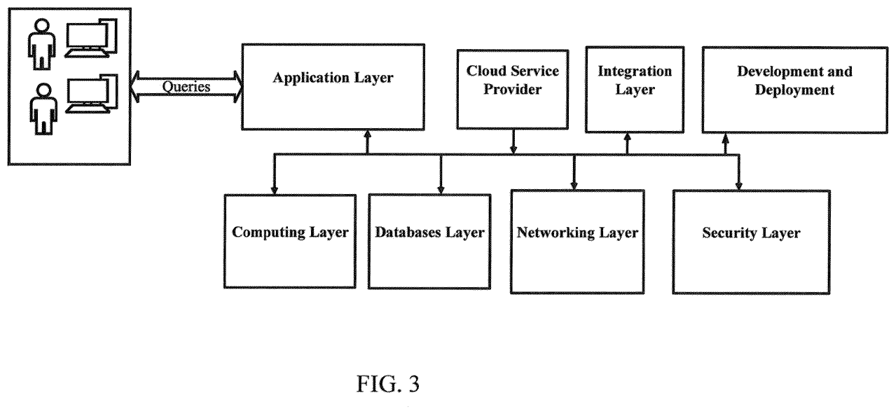

FIG. 3 shows a block diagram of the cloud-based implementation of the IPRM system for the construction and use of the IPRM networks according to the present invention. The application layer includes frontend applications (e.g., HTML, CSS, JavaScript, React, Angular, iOS/Android apps) that present data, collect user input, and send requests to backend applications (e.g., Node.js, Python (Django/Flask), Java (Spring), .NET, Go). Middleware applications (e.g., message queues such as RabbitMQ and Kafka) connect components or services, enabling data exchange, load balancing, authentication, and logging between frontend and backend or between microservices.

As shown, the IPRM system includes a computational layer that can use virtual machines, containers (e.g., Docker or Kubernetes), or serverless computing platforms (e.g., AWS Lambda or Azure Functions). These computational resources are required for document processing, concept extraction, concept node attribute management, CRUD operations, handling complex sequences and modifiers, incremental updates, and running algorithms for network traversal and cluster identification within the IPRM system.

The computational layer includes computational modules that build each IPRM network. through steps such as concept extraction, metadata integration, and the creation of co-occurrence matrices. The computational layer also includes computational modules that detect patterns across multiple disciplines, enabling novel observations and revealing unknown unknowns. AI engines, combined with machine learning and statistical algorithms, enhance pattern recognition and anomaly detection.

The computational layer interfaces with a database layer that embodies the IPRM networks. The database layer comprises relational databases (e.g., MySQL, PostgreSQL, RDS), NoSQL databases (e.g., DynamoDB, MongoDB), object storage (e.g., S3 buckets), or file storage (e.g., EFS, Azure Files). The database layer also stores raw document data, document and section attributes, concept nodes and their relationships, identifiers, and references to ontologies for interoperability and mapping.

A query-processing application in the IPRM system traverses edges in each IPRM network to find solutions to queries submitted by users who interact with the front-end application layer, which also presents responses to those queries. Responses are generated based on data relevant to nodes, even if those nodes were not explicitly included in the query. Each IPRM network is updated in response to queries, ensuring its relevance and adaptability over time. Users can submit queries involving multiple nodes, and the IPRM system generates responses that include relevant data not explicitly mentioned in the query. For example, a query about the linkage between lung cancer, emphysema, and reduced cardio performance might return the context that individuals who use tobacco products have an increased probability of developing these conditions. The IPRM system allows expansion of one IPRM network to other IPRM networks by dynamically creating concept node groups based on the concept nodes included in a user's query and the relationships identified by each IPRM network.

A data integration layer implements APIs (REST, GraphQL) via serverless functions or containerized services that support CRUD operations. The data integration layer maps each operation to a serverless function, typically triggered by HTTP requests, e.g., “POST” (to Create), “GET” (to Read), “PUT” (to Update), and “DELETE,” through an API gateway.

The IPRM system can also employ logging services (e.g., CloudWatch Logs, ELK Stack), monitoring tools (e.g., Prometheus, Grafana), and alerting and notification systems (e.g., SNS, Azure Alerts). A modeling layer can be built using tools within a development environment with cloud-based, containerized microservices and scalable computing resources.

A networking layer can be provided by a Virtual Private Cloud (VPC), subnets, and gateways (e.g., Internet Gateway, NAT Gateway). The networking layer enables launching resources (servers, databases, etc.) in a virtual network. In one embodiment, security is maintained through Identity and Access Management (IAM), encryption (e.g., KMS for key management), network ACLs, and monitoring and logging (e.g., CloudWatch, Azure Monitor).

The following variables and definitions apply to characterizing the reference modes generated by the IPRM System. Except for the distance, all variables are positive integers.
n=number of nodes (concepts); its use depends on context: in a path, it's the number of nodes between two nodes, while in a cluster or grouping, it is the total number of nodes included in the cluster
N=total number of nodes (concepts) in an IPRM
k=number of edges (k for “connections,” a standard notation in networks, also sometimes called the number of links or the rank of the node) that a node has to other nodes, representing the co-occurrence of that node with the others
K=total number of edges in an IPRM, never more than N(N−1)/2, and typically far less
w=the weight of a connection, that being the total number of documents within which a co-occurrence of the two connected nodes has been found
d=distance between two nodes, equal to the inverse of the weight; that is,

$$d = \frac{1}{w}$$

C=centrality of a node, which is a sense of how important a node is within the IPRM; equal to the square of the total number of edges that node has, times the sum of all the weights of those connections (this is a non-standard definition, particular to the IPRM); that is,

$$C = {k}^{2} {\sum }_{i = 1}^{k} {w}_{i}$$

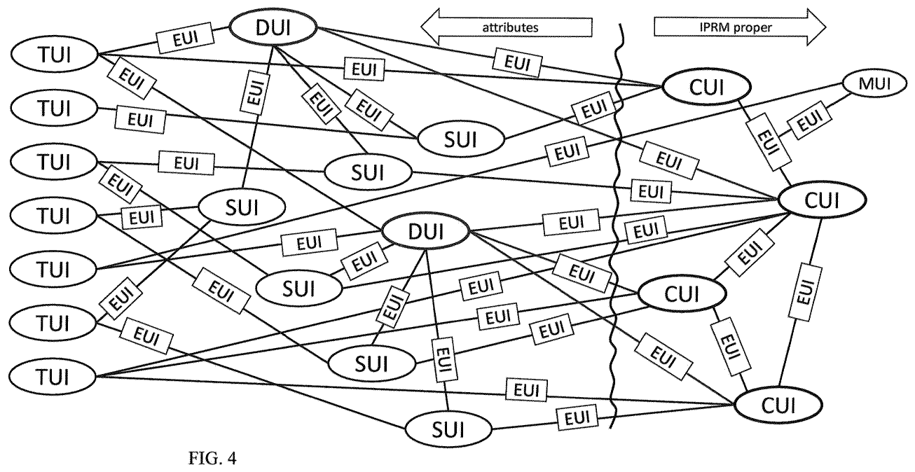

FIG. 4 shows an example relationship among the unique identifiers used to access a specific element within the IPRM system. All unique identifiers defined here are described in more detail in the individual sections above.
DUI=document unique identifier, is an identifier for source documents processed for by the IPRM system.
SUI=section unique identifier is a unique identifier that locates where in a document a concept was found.
TUI=type (or tag, or taxonomy) unique identifier is an identifier for categories used to index and cross-reference types of entities within the IPRM system.
CUI=concept unique identifier is the unique identifier of a concept node within the IPRM system. In one embodiment, CUI is a standard notation used in formal ontologies.
EUI=edge unique identifier is the unique identifier of an edge (also known as a link or connection) between two other unique identifiers. EUI is the element in the IPRM system that creates the network of relationships.
MUI=modifier unique identifier is an identifier used for either a temporary or permanent annotation or modification of one or more elements within the IPRM system.

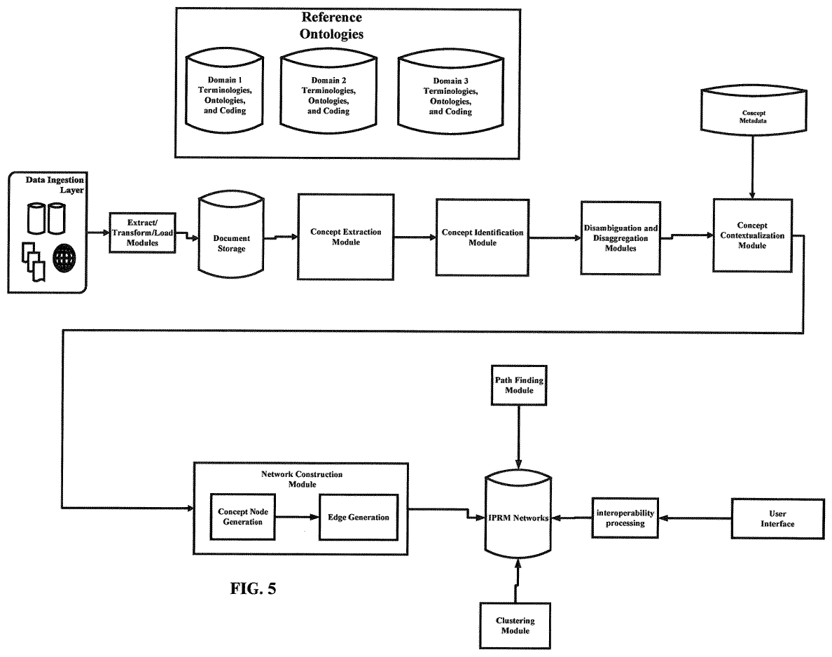

FIG. 5 shows a data flow diagram within the IPRM platform. A data ingestion layer collects input from document sources covering a broad and expanding range of subject matters. Any document processed to extract concepts for inclusion in the IPRM system is identified by a DUI in the database layer. Additional attributes (metadata) associated with the document are then indexed to that DUI. An Extract, Transform, Load (ETL) module processes data from various document sources (databases, APIs, files, etc.) for integration, especially for data warehousing and analytics. During the ETL process, raw data, which may be in different formats and structures, is converted into a suitable format or structure for analysis by cleaning data, removing duplicates, filtering, aggregating, joining tables, or applying business rules. The converted data is stored in a central data warehouse for use with intelligence tools.

A concept extraction module extracts concepts from stored documents using text analytics processing modules such as natural language processing (NLP) and models such as long language models (LLMs). One feature of the IPRM system is the creation of relationships between concept nodes and formal ontologies. The concept extraction module establishes a reference list of concept nodes, often using standardized formal ontologies. The extraction process compares the words and phrases in each document to this master list of concept nodes, including variations in spelling and abbreviation. For documents with multimodal content (such as video or narrative text), salient concepts are extracted using methods such as machine learning algorithms that identify and collect the relevant concepts from the content, regardless of format.

A concept identification and labeling module identifies the extracted concepts by assigning each concept a CUI, making it available as a node in the IPRM system. If the concept is already represented in the IPRM system, the CUI maps to an existing identifier; if it is being added for the first time, a new identifier is assigned. Once the CUI is assigned, a concept disambiguation and disaggregation modules distinguish between concepts that may share similar linguistic forms but represent different meanings or entities. The disaggregation process separates compound concepts into their individual components, recognizing when the compound represents a distinct, standardized concept. A concept contextualization module retrieves contextual data in the form of metadata associated with a corresponding CUI comprising attributes and categories that are associated with the corresponding concept nodes. Such meta data can include concepts' synonyms, abbreviations, spelling variants, serial position, logical section, matching source and relevant ontology indexes as well as TUIs.

A network construction module generates concept nodes that represent each concept identified by a CUI. Relationships between concept nodes are represented by edges identified by corresponding EUIs. The edges between concept nodes are created by detecting co-occurrence of concept pairs in each document. The edges are represented by occurrence matrixes module determines strength of the relationship between concept pairs. If the relationship is new to the reference model, it is entered into the co-occurrence matrix with an initial count of 1. If the relationship already exists in the co-occurrence matrix, its count is increased by 1, thereby increasing the weight of the edge. Because the counts represent the total number of documents in which each relationship was detected, the strength of the relationship between any two concepts can be weighed by that number. Mathematically, the number of combinations of n concepts taken 2 at a time (=n(n−1)/2 possibilities) means co-occurrences accrue on the order of n2, where n is the number of unique concepts extracted from a document.

As stated above, the strength of the relationship between two concept nodes in an IPRM network is determined by counting how many documents feature both concepts together. Each additional document in which the concepts co-occur incrementally strengthens the relationship between those nodes, increasing the weight of the corresponding edges that connect concept nodes. For example, in literature, each word can be treated as a concept node, and a matrix can be constructed to relate those concept nodes to one another based on the number of times they co-occur across pages in the books. Each resulting IPRM network is scale-free, meaning it forms scattered clusters or “starbursts” of connections rather than a uniform lattice. Although the network is not fully connected in the mathematical sense, it is possible to find continuous paths between any two concept nodes, demonstrating the interconnectedness of concept nodes through their relationships. Accordingly, the relationships between concept nodes, connected by weighted edges, reflect practical relationships, forming a scale-free, interconnected system that enables lateral navigation across domains. IPRM networks can be subject to artificial intelligence and data analytics processing to serve various needs based on applicable deep learning, machine learning, and other models stored in a repository.

The strength of an edge between two concepts increases over time. This process is similar to how weights are assigned between nodes in neural networks, but in the IPRM system, the weights are engineered and can be updated incrementally as new documents are added, allowing transparent tracking of how relationships or edges are formed and reinforced. Thus, co-occurrence in the IPRM system is used to compute edge weights in the network of concept nodes. The document ID where the relationship was detected is also recorded (e.g., in a one-to-many table where one relationship may appear in many documents).

As new documents are added, the IPRM system processes new concepts and relationships while existing concepts and relationships continue to accrue counts. Over time, additional metadata is computed and associated with concept nodes. This attribute measures how important a hub the node is. Although the value relies on both the total number of edges (or connections) a node has (a number known as its rank) and the combined weight of those connections, the node's rank is squared, so it has more overall impact on centrality. The centrality value is dynamic as more connections are added, and more weights are accrued. For example, the “centrality” of a concept might be a measure of how important and connected the concept is, and it might be computed by summing the weights of all its relationships (i.e., adding the counts associated with each relationship) and then multiplying by the square of the total number of relationships it has:

centrality=(Σweights)*(Σconnections)²=(Σw)*(Σk)²

Such a value would help rank order the possible paths between two concepts that are not directly connected, as further described later.

As with documents, the attributes of concept nodes can be represented as nodes themselves when appropriate, with such attribute nodes connected to their parent concept within each IPRM network by zero-distance (infinite-weight) connections. On the other hand, attributes such as synonyms or indexes to formal ontologies can be confined to related lists or tables instead.

### 16. IPRM Methods

The IPRM system uses algorithms to compute results for creating IPRM networks. These algorithms update the IPRM networks in real time and enable traversing them to understand how concept nodes are connected, identifying various related concepts or clusters.

### 17. CRUD Operations

Create, Read, Update, and Delete (CRUD) operations are the four basic functions for managing data in a database or information system. In the IPRM system, CRUD operations are used to interact with databases or data storage systems. As shown in FIG. 5, these operations enable the interpretability and accessibility of the IPRM system to end users. CRUD operations allow the incremental addition of information to an IPRM network, whether by automated document processing or by subject matter experts. The CRUD feature enables the tailoring and micro-adjustments of the IPRM networks. For example, concepts can be combined or split, connections can be manually added, altered, or removed, and annotations, tags, and modifiers can be attached. These capacities enrich the IPRM system and extend its relevance, applicability, and utility. As a result, the created IPRM networks can be built incrementally, and the addition of new information has linear, predictable impacts on the larger network.

The ability to manually perform basic CRUD operations that enable fusing or dividing existing concepts could have been useful in the early days of COVID-19, when an unidentified respiratory illness was detected in Wuhan. The respiratory illness might have been represented as a manually entered question mark concept in an IPRM. When the virus was identified as a Severe Acute Respiratory Syndrome (SARS) virus, the question mark concept might then have been fused into an existing SARS concept. Finally, when the virus was fully sequenced and distinguished as the SARS-CoV-2 virus, an IPRM's SARS concept might then have been divided into two concepts, the general SARS concept from before and the new SARS-CoV-2 concept. To complete the sequence of events, another new concept, COVID-19, could have been manually inserted into the IPRM to represent the newly described disease state, along with additional new related concepts representing relevant new lab tests and the like.

The incremental addition of new concepts and the manual adjustment of fusing or dividing concepts can occur in real time, and each IPRM network can immediately grow relationships between the new concepts and the larger IPRM network as new documents emerge. This capability to insert human edits as knowledge evolves in real time is distinct from how a Large Language Model (LLM) works. An LLM is built, at the cost of enormous amounts of energy, from billions of documents all at once; the LLM will not be recomputed until many months later, at the earliest, with a new set of billions of documents.

### 18. Path Finding

Path finding between concept nodes is one of the methods used in the IPRM system. The purpose of finding different paths between two nodes that are not otherwise directly connected is to generate additional related nodes that may be relevant to an inquiry or decision. The use cases described further below illustrate why this is useful. Note that the various path methods defined here are not guaranteed to generate a single unique path; that is, more than one path may be a solution to the method used, as further described below.

### 19. Clustering

The IPRM system employs clustering methods to generate a set of relevant related nodes, associate detailed characterization and attributes with concept nodes, and then use these attributes to organize clusters within the IPRM networks. Clustering within the IPRM system identifies groups of concept nodes that are tightly intertwined, meaning they co-occur repeatedly and form discernible patterns. Clustering is thus a direct outcome of the phenotyping process, as it groups concepts based on their shared or similar phenotypic attributes, which in turn enhances understanding of the broader conceptual network. These clusters—sometimes called “constellations”—represent meaningful groupings of concepts that reflect real-world relationships, such as a set of symptoms that commonly appear together or a group of related medical diagnoses. As further described below, different clustering methods create different perspectives on the same problem, which encourages lateral thinking. When clusters are composed of different categories of nodes (that is, attached to different TUI tags), entirely new possibilities emerge for managing complex, multi-disciplinary, multi-faceted situations. For example, concept node groups can be created by grouping multiple concept nodes, each representing a concept such as symptoms, signs, context, diagnoses, medicine, studies, procedures, or consultation.

### 20. Illustrative Example

A children's literature example can illustrate concept extraction by the IPRM system for creating an IPRM network according to the present invention. In one example, 13 children's books were selected as a sample, and each word in these books was treated as a concept node (with the exception of a few stop words such as “a” and “and,” which were eliminated because of their ubiquity across all pages and all books and because they add significantly to the computational overhead of producing the reference model without adding any insights of value). Together, they contained 1198 unique words across 419 pages of text, and each page was treated as a document identified by a DUI. It should be noted that, while the children's literature example is deliberately small, a full reference model would typically have hundreds of thousands of concepts and tens of millions (or more) of connections between them.

As explained above, the IPRM platform identifies and counts how many times each word concept appears and how many co-occur within each page document. These identified concept words are then mapped to unique identifiers and used to update the children's literature IPRM network by recording the relationships (edges) between co-occurring word concept nodes on each page of each document. The total number of possible two-word pairs for 1200 words is on the order of 720,000. However, only 52,967 pairs of words in the selected books occurred across the 419 pages. Because the children's literature reference model forms scattered starbursts of connections, with less than 8% interconnected (52,000/720,000), it is still possible to find a continuous path between any two arbitrary word concept nodes anywhere in the network. Although there are continuous pathways connecting the word concept nodes, the entire network is nowhere near fully connected, and concept relationships co-occur with specific patterns in the children's literature example as a real-world practical representation.

In this example, fully connected clustering is used to identify sets of concept nodes in the children's literature IPRM network, where each concept node is directly connected to every other concept node in the set. Computationally, fully connected clustering is achieved by performing a series of set intersections. That is, for each seed concept (A, B, C, etc.), the set of concept nodes connected to it is determined before finding the intersection of these sets. Seed nodes are directly related to fully connected clustering because they serve as the initial set of nodes used to define the cluster criteria. By choosing one or more seed nodes, the search space is dramatically reduced from a large number of possible words or concepts to a much smaller, more relevant set of nodes that are fully connected to the chosen seeds. The result is the set of concept nodes that are connected to all seed concepts simultaneously. This makes the set of fully connected nodes manageable and interpretable, allowing for meaningful ranking and easier manual review of relevant concepts. The aggregate weighting of these connections further refines the relevance of each concept within the reduced set. Thus, fully connected clustering is a series of set intersections-identifying what concepts are connected to A AND to B AND to C, and so forth-resulting in a cluster of concepts that share direct connections with all seed concepts. This method dramatically reduces the search space and highlights the most relevant relationships for further analysis, as further described below. The term “search space” refers to the total number of possible words or concepts and their connections that must be considered when analyzing or querying a dataset.

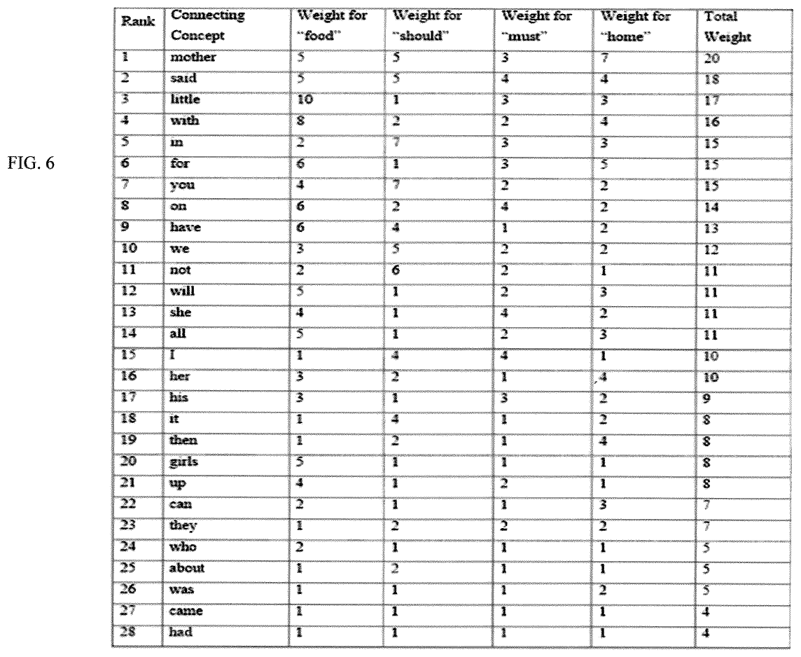

FIG. 6 shows a weight table for the children's literature example. As shown, for the seed group of “food,” “should,” “must,” and “home,” the word “mother” was most strongly connected to the group of 4 concepts. The words “said” and “little” also scored highly among words/concepts that were fully connected to the group. Using the seed group of “food,” “should,” “must,” and “home” as a query, the search space has been dramatically reduced from 1200 words and 52,000 connections to 28 words, all fully connected to the seed group. Within this much smaller space, the aggregate weighting of the connections creates a meaningful ranking of relevance, making it much easier for either manual review of the suggested word concepts or follow-on computation as part of a longer information pipeline. “Mother” has the highest rank in this example, which makes sense semantically, within the context of children's books, as a concept that's closely related to words like “should” and “home,” and so on. But there is an entire neighborhood of 28 concepts that are all closely connected here. It should be noted that the list of 28 concepts here is not necessarily a fully connected cluster. That is, while they are all fully connected to the 4 original seed concepts, they may not be fully connected to one another.

Each IPRM network is a scale-free network of word-concept nodes, meaning it does not form a uniform lattice of connections but instead exhibits scattered starbursts of connections. This is because the network's transitive closure contains the complete network, or, alternatively, the percolation threshold has been surpassed. For example, in a connected network of three points A, B, and C, transitive closure means that a path exists from point A to point C if there is a path from point A to point B and a path from point B to point C. In a network of connected nodes, the transitive closure is the set of all possible connections that exist by following paths through the network. If the transitive closure contains the complete network, it means every node (point) can reach every other node, directly or indirectly. The percolation threshold is a concept from statistical physics and network theory. It's the critical point at which enough connections exist in a network so that a large, connected cluster forms. Surpassing the percolation threshold means the network has enough links so that path exists between any two arbitrary nodes in the network.

Although there are continuous paths connecting concepts, the entire network of word concepts in the children's literature IPRM is nowhere near fully connected in the mathematical sense, meaning concepts do not co-occur randomly but rather co-occur with specific patterns (phenotypes). Thus, the nature of concept relationships comprises patterns that capture the practical knowledge of how things work in the real world.

By adding more seed nodes as initial requirements, the resulting list would become even shorter, and the weighting (ranking) would become more clearly stratified. This is because there is a power-law reduction in the search space when using seed nodes to find related nodes: 1 seed node might connect to 200 other related nodes, 2 seed nodes might reduce that number to 50 or so, 3 seeds might reduce that to 35, and 4 might reduce it to the 28 nodes as in the example above. The greatest reduction in search space occurs with the first and second seed nodes; adding more seed nodes beyond that continues to reduce the search space of possible relevant connections, just not as precipitously.

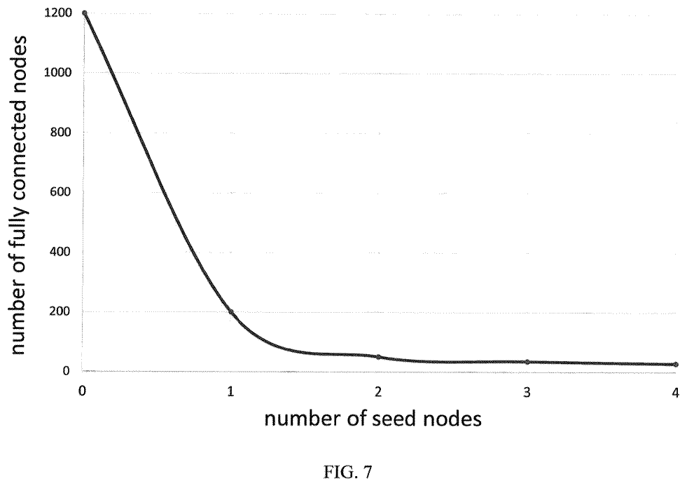

FIG. 7 shows a graph depicting a power-law reduction in the search space. This graph shows that as more information about an unknown or missing concept becomes available, the likelihood of uniquely determining what that concept must be increases, thereby finding an unknown known. That is to say, the IPRM system captures an extensive ecosystem of information, so if that information is captured through document processing, the IPRM can make it known. When an end user is searching for information, they are trying to find something they don't know amongst a network of known things—unknown knowns. Because of the extensive network of concepts and connections, finding an unknown known is more efficient by leveraging what is known about it, even if it's just generalities. What is known seeds the search and effects a power-law reduction of the search space to produce manageable possibilities. In this way, finding unknown knowns is a matter of finding what's missing from a pattern. In law enforcement, this is how cases are built to determine the identity of an unknown perpetrator during detective work, or, returning to the medical analogy, how enough symptoms, physical findings, and test results can uniquely determine a diagnosis and rule out everything else.

### 21. Clustering Methods

As stated above, clustering is the process of grouping sets of closely related nodes. All clustering methods aim to generate sets of relevant, related nodes, but different methods offer different perspectives and encourage lateral thinking. Clusters can include nodes from different categories, opening up new possibilities for managing complex, multidisciplinary situations. Normally, standards for terminology or concepts are used to facilitate apples-to-apples groupings or comparisons. As a reference model, however, the IPRM allows broader thematic clustering and comparisons, so that apples might be reasonably compared to oranges as well.

One clustering method is Nash clustering, which finds a closed set in which each concept's strongest weight connects to another concept in the same set. In other words, the set is in greedy equilibrium, also known as Nash equilibrium. These sets can have unusual topologies, such as a long linear tail connected to a pair whose strongest weights connect to each other, or a forking set where concepts have two equal maximum weights that point in different directions. There are no guarantees that a Nash set will close in a reference model, but even open sets create an interesting set of relationships. A Nash cluster computation involves following the connection with the strongest weight of the starting concept to the next concept and repeating this until the set closes.

Another clustering method is attribute adjacency, in which concepts are grouped based on how similar or “adjacent” they are in terms of their attributes. In other words, attribute adjacency can identify clusters based on the similarity of the attributes of concepts, even when these clusters are not observable from inter-nodal relationships. Some attributes provide syntactic information, that is, information about how a concept is used, such as whether a concept is a medication or a diagnosis. Other attributes provide more details about a concept, such as a weight or an efficiency, and can carry numerical data attached to the attribute. Both numerical and categorical attributes are useful in finding new clusters.

Under categorical adjacency, concepts that share the same attributes form a cluster. For example, a witness to a crime sees a white van with no rear windows driving away. So vehicles with attributes that include a white color, a van or boxy shape, and no rear windows become a relevant cluster, regardless of the make and model, and regardless of whether the various vehicles that have these attributes are otherwise connected to one another with edges within the reference model.

Numerical adjacency relies on the mathematical calculation of the cosine of the angle between two vectors. Cosine similarity is widely used to measure how similar two vectors are, especially in high-dimensional spaces (such as text analysis and machine learning). If two concepts have numerical values associated with the same TUI attribute (that is, the two numbers are different measures of the same thing), the IPRM system can recognize that if the two numbers are close, the two concepts must be similar with respect to this attribute. This means these concepts are likely to be closely related, regardless of the weight of the edge between them (if they even share an edge).

When two concepts have multiple numerical attributes at once, they are mathematically known as dimensions. In some cases, while the two concepts might appear quite closely related based on one attribute alone, other attributes might pull them further apart. In this situation, measuring the closeness of two concepts may require considering their attributes together. Moreover, finding the closeness of whole clusters of concepts with different numerical values associated with the same TUI attributes is akin to finding clusters with different numerical values for the same dimensions.

Numerical adjacency between two concepts with multiple numerical attribute values can be achieved by normalizing all such values on a scale from 0 to 1. Some numerical attributes, such as efficiency (expressed as a percent), may already be on a 0-to-1 scale. Other values would need to be divided by the attribute's top range, which can be done on the fly. Then, for each concept, the normalized dimensions can be treated as the components of a single vector that characterizes the concept all at once. The distance between any two of those vectors can then be determined by the cosine of the angle between the multidimensional vectors and the dot product of the normalized unit vectors. As a result, determining numerical adjacency reduces to solving an arithmetic problem, where the cosine of the angle between two multidimensional vectors is the sum of the individual component products.

For example, for a concept A with normalized attribute numbers (vector dimensions) a1, a2, a3, and a4, and a concept B with normalized attribute numbers (vector dimensions) b1, b2, b3, and b4, the cosine between A and B is the sum of the term-wise products: a1b1+a2b2+a3b3+a4b4. This calculation can be done on the fly; moreover, if the two concepts don't share a specific attribute—say concept B doesn't have anything for b4—then the term drops out altogether (a4×0=0). This makes the computation of the cosine of the angle between any two concepts the product of terms returned from a SQL inner join, which is computationally trivial.

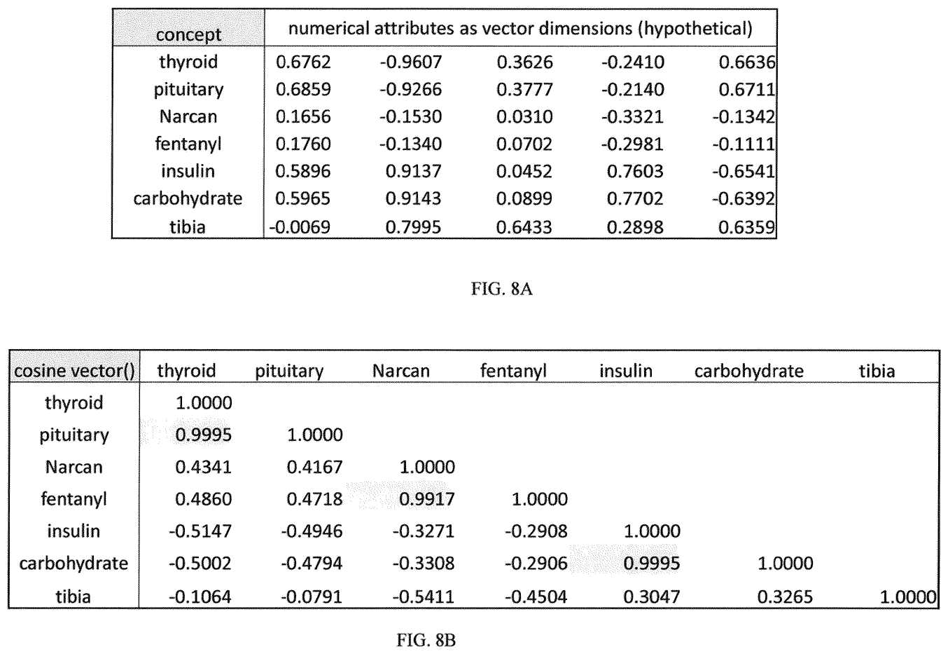

FIG. 8A shows various medical concepts with hypothetical numerical values as vector dimensions. FIG. 8B shows the cosine between any two concepts shown in FIG. 8A. As highlighted, a cosine near 1 between two concepts indicates they are closely related, whereas a cosine near 0 indicates unrelated concepts. Nodes with numerical attributes that form adjacent vectors can be grouped into clusters of concepts related by how they are used (their syntactic relationships) or by other facets captured by numerical data, such as confidence in data elements or fuzzy set clustering. This approach can reveal new phenotypes that are not explicitly documented.

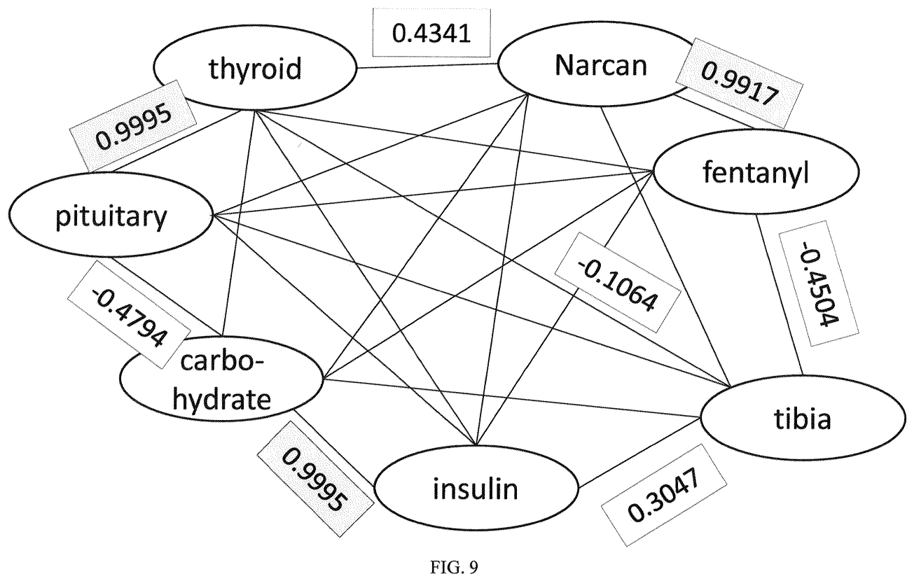

FIG. 9 shows a diagram of clustering based on numerical attribute adjacency. As shown, nodes with numerical attributes that form adjacent vectors can be grouped into clusters of concepts related by how they are used (their syntactic relationships) or by other facets captured by numerical data, such as confidence in data elements or fuzzy set clustering. This approach can reveal new phenotypes that are not explicit in documents. It should be noted that with categorical attributes, the numerical value for the TUI is 1, meaning the concept is 100% a member of that category. With 1's as the numerical values for categorical attributes (or 0's if a concept does not have that TUI), the same cosine method can be used. Thus, the cosine method can be seen as a more generalized version of the categorical method for computing attribute adjacency, where categorical and numerical attributes may be combined into a single calculation.

Another clustering method uses fuzzy sets and probability clusters. Fuzzy sets are a mathematical concept in which membership in a set is not either-or but rather a matter of degree. For example, people who are overweight have a high Body Mass Index (BMI), but BMI is a continuous range, and there are no natural breaks in BMI that clearly demarcate “overweight.” If a collection of people who are overweight is created, a person with a BMI of 29 might have 50% membership in that set, someone with a BMI of 31 might be 75%, and someone with a BMI of 40 might be 100%.

The IPRM system uses a fuzzy set to reduce the search space by combining information. For example, in the medical literature, there has been an emerging observation that some people who are overweight do not have high blood pressure and do not have insulin resistance, both of which are common in overweight patients. These patients form a subgroup of the larger population that might be important to research. Normal blood pressure is a continuous range, as is a normal glucose tolerance test, which serves as a proxy measure for insulin resistance. Fuzzy sets of all three attributes—overweight, normal blood pressure, and normal insulin resistance—could quickly identify a group of patients who are likely candidates for research, with some patients being clear members of the subgroup and others less clear but still worthy of further evaluation.

As with fuzzy sets, any collection of uncertain facts can form a probability cluster. Instead of a fuzzy measure of membership, the degree of certainty about a fact can be used. For example, forensic analysis of three DNA samples in varying states of degradation can assess whether they match a fourth clean sample by assigning probability attributes to each sample, such as 10%, 50%, and 65% confidence. Those degrees of certainty, in and of themselves, may help guide decision-makers about how applicable the DNA samples are to an investigation, but the real advantage comes from being able to look across multiple sets of facts, each with varying degrees of confidence, and collect together all those with high certainty. This is useful when there is a roadblock in the case and an investigator needs to go back to what is known, not what is supposed.

Both fuzzy membership and probabilities can be expressed as numerical attributes of a modifier. For the DNA example, a modifier attaches to two concepts, the first representing one of the DNA samples and the other representing the comparison DNA. The flag is “ordered,” the TUI modifier is “match,” the number is 0.10 (for 10%), and the second TUI for how to use the number is “degree of certainty.” The fuzzy set example would work the same way.

Documents can have attribute adjacency, as shown in FIG. 5 and described above in connection with the children's literature example. However, document adjacency can also be computed using a concept-modified version of the Term-Frequency Inverse Document-Frequency (TFIDF) calculation, as used with individual words in natural language processing. A document titled “Baseball Legends” is more likely to relate to baseball than to legends. In TFIDF, the computer counts how many times a word appears in a single document (the TF part) and divides it by the number of times the term appears across all documents in a corpus (the IDF part). This way, a word like “the,” which will undoubtedly appear many times in a single document, is divided by a large number representing all the many other documents the word “the” also appears in, and so its TFIDF score is quite low. Meanwhile, a word that is used infrequently across documents but appears quite often within a single document will have a high TFIDF score. The implication is that the second word, with its higher TFIDF score, conveys more of the document's gist.

In this embodiment of the IPRM system, concepts, rather than terms, are tracked within and across documents. Concepts are extracted from a document because they already have an important semantic impact on the document and may be represented in the document by many different terms or phrases. A concept is a higher-level abstraction than a term. However, the counts of concept occurrences within a document, as well as the counts of occurrences across documents, are a natural byproduct of assembling a reference model. This means that a concept-modified TFIDF score can be computed for every document without any additional effort in constructing the reference model. As a result, a ranking of those concepts can be produced that are common in one document but less common across the others, implying the concept is a key point in that document. For example, a medical record from Boston that mentions malaria many times is probably about malaria, given that most records in Boston won't use that word. With concept rankings for each document, similarities across documents—document adjacency—can be easily discerned. Connecting the concepts within adjacent documents provides yet another method for finding related clusters.

The IPRM system can use inter-cluster paths and super clusters to cluster concept groups. Relationships between two or more concept clusters can be complex and even chaotic, depending on the complexity of the clusters and the pathways between them. However, understanding how two or more clusters are related is often necessary, and discernible patterns often emerge. The IPRM system renders these relationships computationally tractable and can reveal otherwise cryptic patterns. For example, consider a cluster of related symptoms, such as fever, rash, and joint pain, and a cluster of infectious diseases, such as dengue, chikungunya, and zika. In this example, the symptoms are primary features of the diseases. Although the diseases belong to a completely different viral family, they all cause the same symptoms. These diseases and symptoms are already directly connected to one another and can be considered members of a superset or supercluster. However, the IPRM can generate alternative (non-direct) pathways between each concept in one cluster and each concept in the other, using methods such as hub-and-spoke or anti-centralized routing. A comparison of these indirect alternative pathways reveals additional insights into the nature of the relationship between the two clusters. When routing through hubs, the common inflammatory pathways of each disease in this example are revealed, explaining why three different diseases manifest the same set of symptoms. Moreover, exploring what other concepts are connected to the common inflammatory pathway hubs might reveal other diseases that also manifest similarly, such as Oropouche, a lesser-known virus that shares the same geography, vectors, and symptoms as the other three. In this example, the common pathway between diseases and symptoms was already known and captured by the IPRM; however, the IPRM can also reveal more subtle or undetected pathways between the clusters.

In healthcare, collecting observations, complaints, symptoms, and the like from a patient to determine a diagnosis is the precursor to formulating a clinical plan. The IPRM system is designed to help generate a ranked list of possible diagnoses, which then helps determine such a plan. The ranked list (the “differential diagnosis”) would most commonly be derived from fully connected clustering, such as the example used for children's literature, but limiting the type (TUI) of nodes to diagnoses. Any clustering method can assist, and fuzzy sets might help generate possibilities that might be less common and possibly overlooked.

For example, a set of 1000 medical documents can be a record of unique patient visits with healthcare providers. For simplicity, a few key symptoms are treated as concepts across all the documents, namely the following 7 patient symptoms: nervous, palpitations, constipation, diarrhea, chest pain, weight loss, and jumpy.

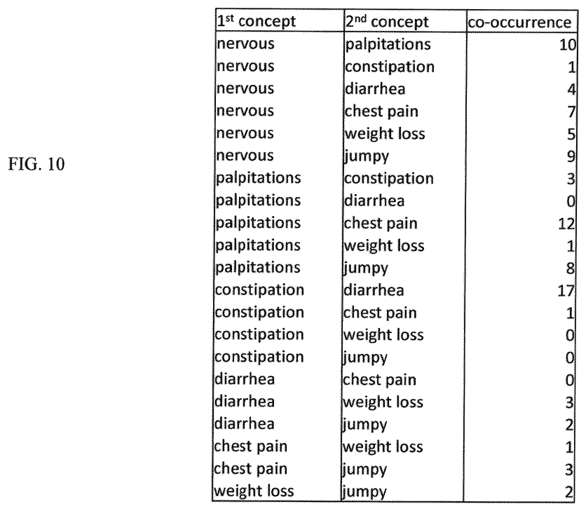

FIG. 10 shows the number of times each of the seven patient symptom concepts co-occurred with another of those seven within the given set of documents. As shown, there are 21 possible co-occurrences. The zeroes on the right indicate that not all of the co-occurrences were found.

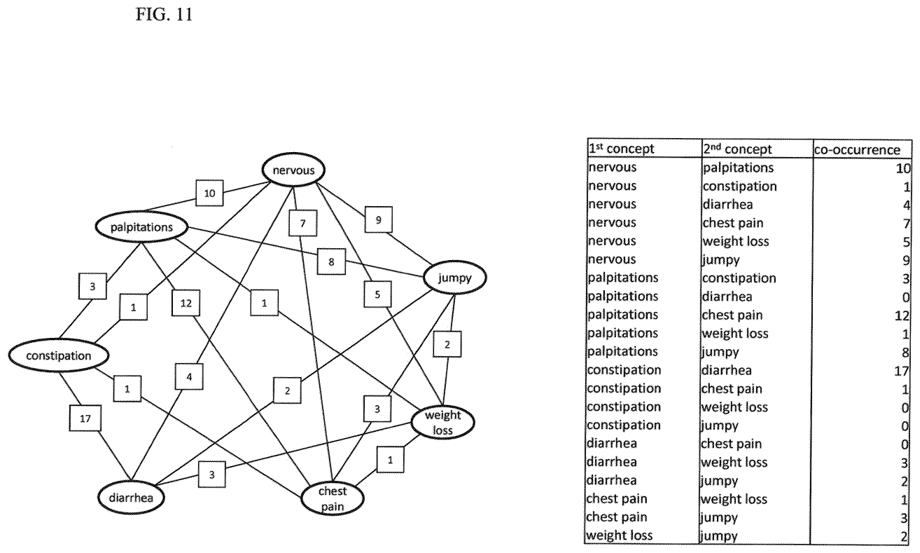

FIG. 11 shows an IPRM network with patient symptom concepts and edges that include the number of co-occurrences between the concept nodes.

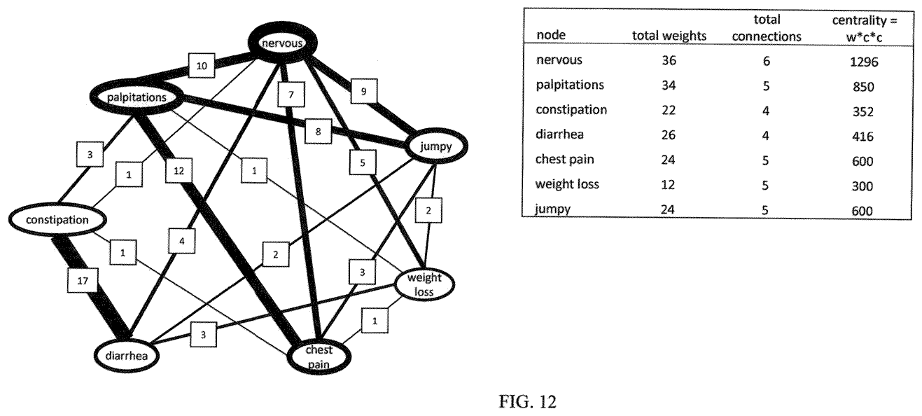

FIG. 12 shows a visual representation of the weighted connections and centrality of the patient symptom concept nodes in the IPRM network. As stated above, centrality is a measure of how important a hub the concept is. Although the value depends on both the total number of edges (or connections) a concept has (a number known as its rank) and the combined weight of those connections, the concept's rank is squared, so it has more overall impact on centrality. The centrality value is dynamic as more connections are added and more weights are accrued.

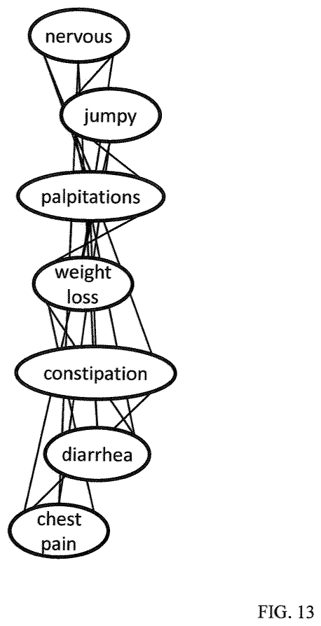

FIG. 13 shows a diagram that rearranges the patient symptom concept nodes to depict the incremental expansion of the reference model (the diagram excludes weights and centrality for simplicity).

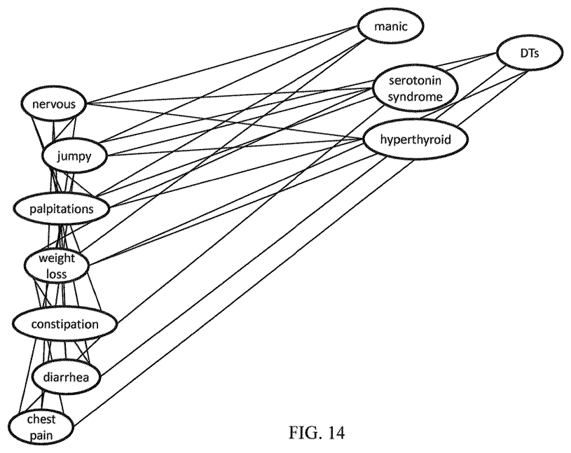

FIG. 14 shows an expansion of the reference diagram with the addition of diagnosis concept nodes that co-occurred with the patient symptom concept nodes.

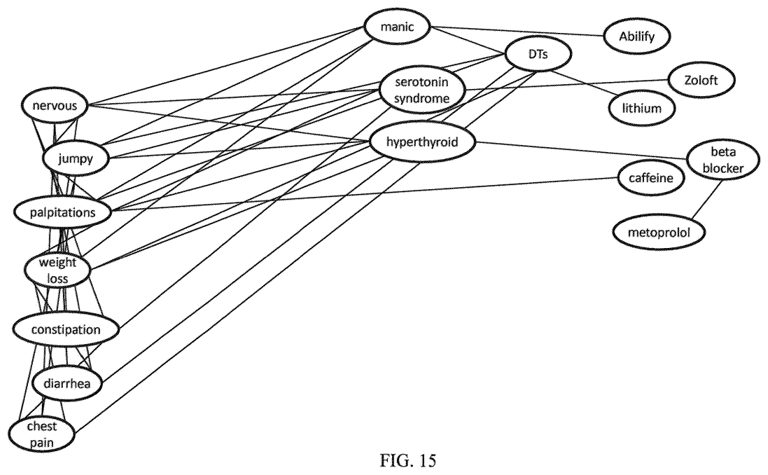

FIG. 15 shows an expansion of the reference diagram with the addition of medication concept nodes that co-occurred with the patient diagnosis concept nodes.

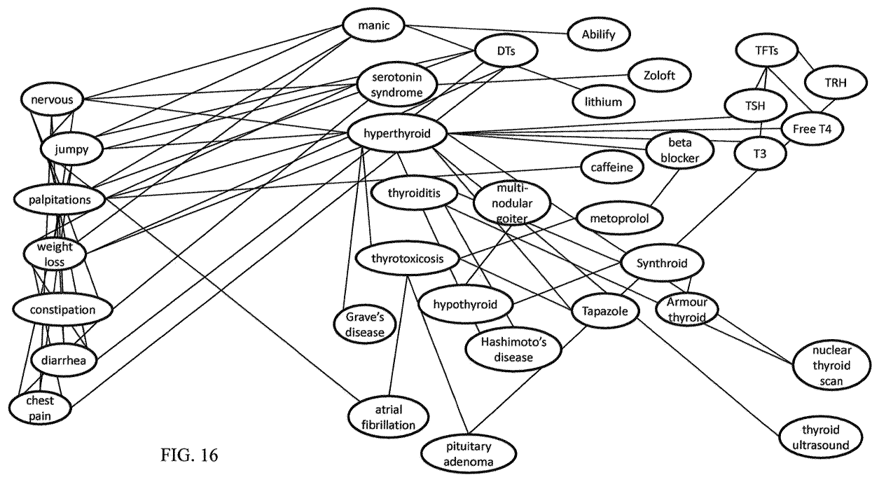

FIG. 16 shows an expansion of the reference diagram by adding other diagnostic concept nodes that co-occurred with the diagnostic concept nodes and by adding lab and study concept nodes that co-occurred with the diagnostic concept nodes.

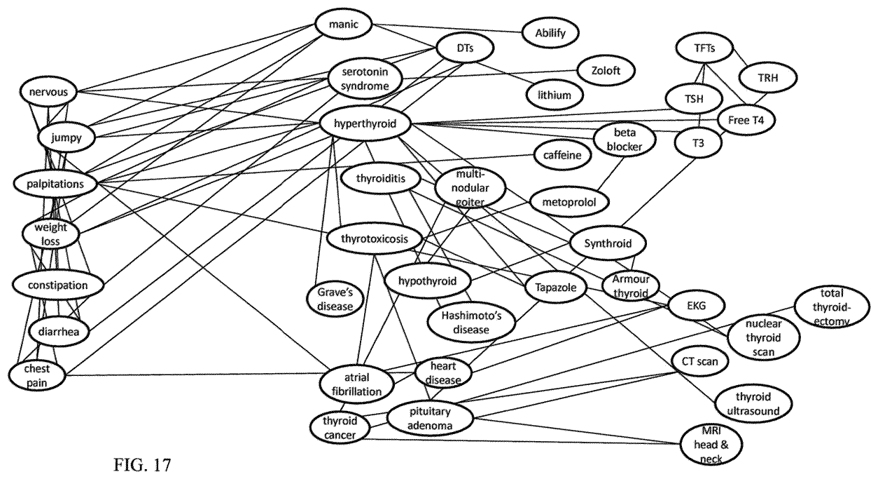

FIG. 17 shows an expansion of the reference diagram with the addition of procedure concept nodes that co-occurred with lab and study concept nodes.

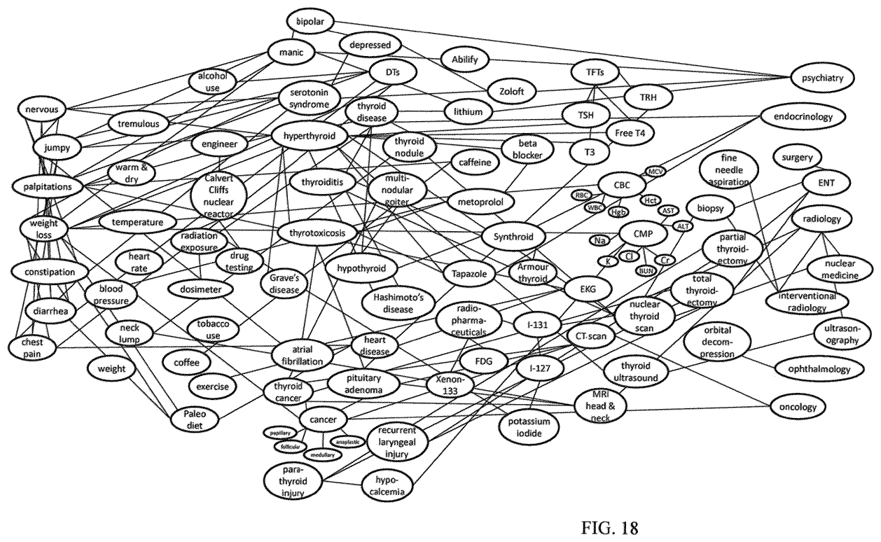

FIG. 18 shows an expansion of the reference diagram with the addition of consult concept nodes that co-occurred with the procedure concept nodes.

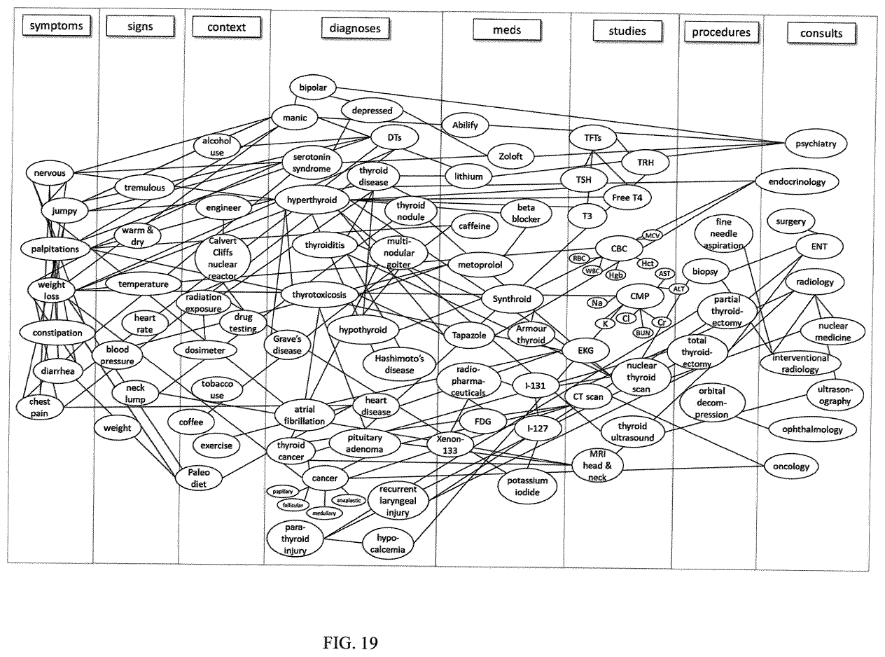

FIG. 19 shows the reference diagram with vertical columns indicating the type of concept metadata associated with each node.

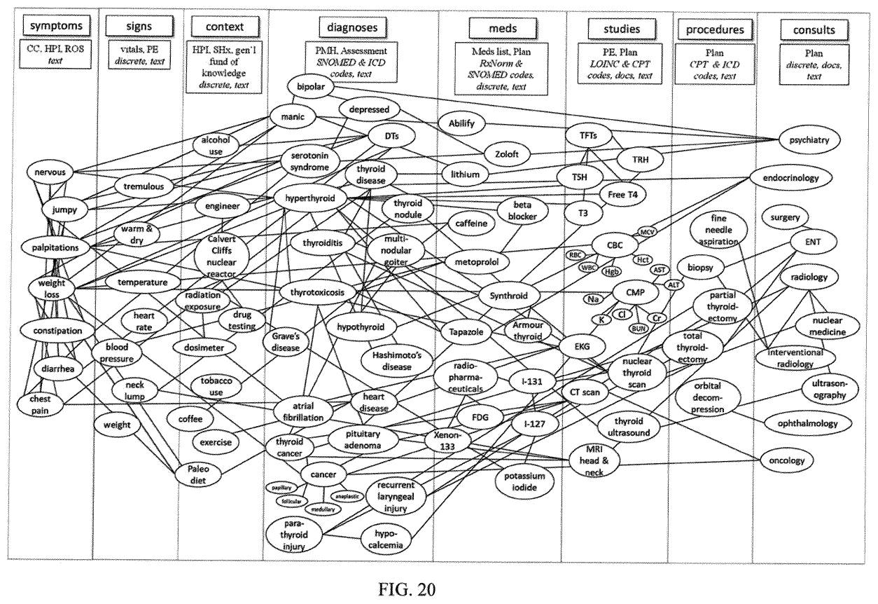

FIG. 20 shows the reference diagram with additional metadata associated with each node, including where in the diagram concept nodes are located and which ontologies they might be indexed to.

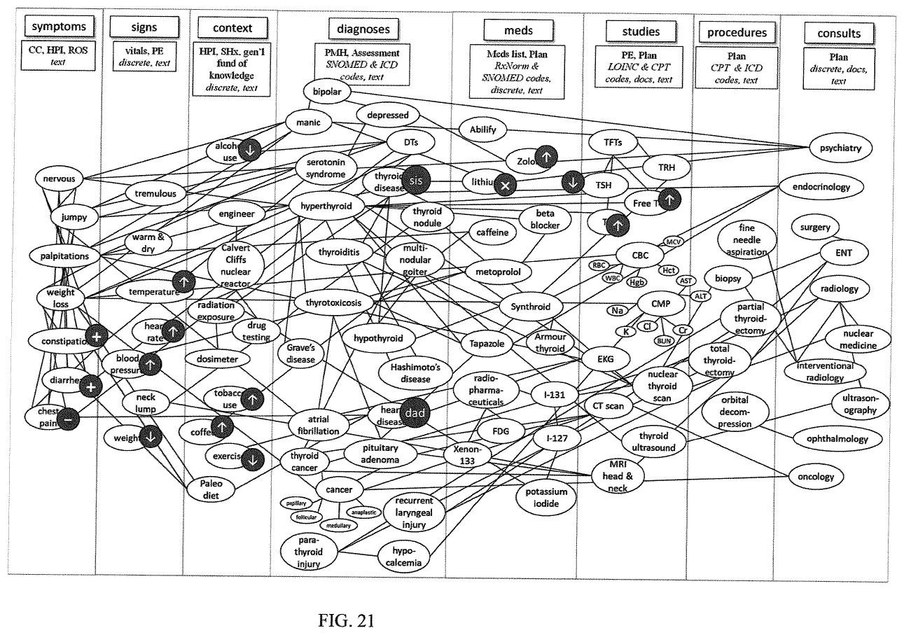

FIG. 21 shows the reference diagram with concept nodes associated with valence attributes (such as rising, falling, presence, or absence) or other contextual attributes (such as personal past history or family history) for a particular document.

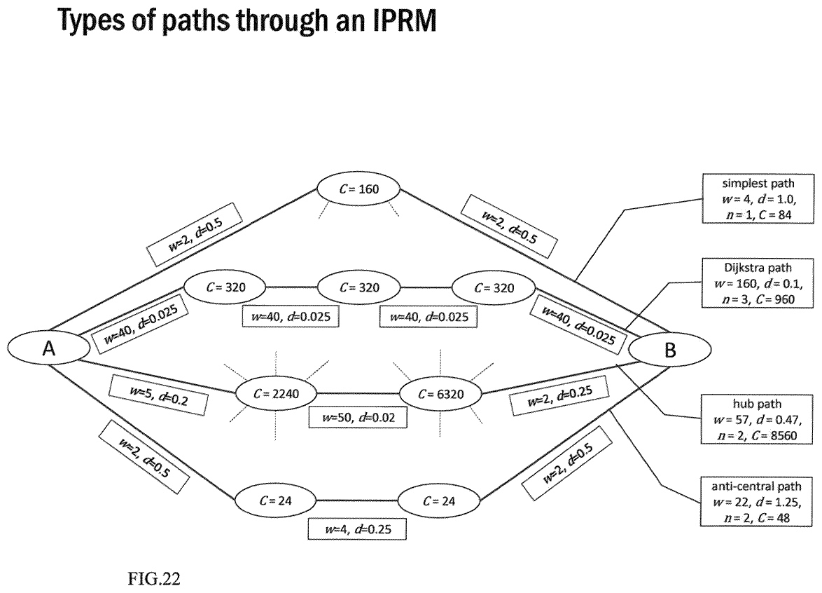

FIG. 22 shows how the IPRM system aligns information design with the cognitive processes in medicine to create a direct correspondence between the knowledge representation and how the knowledge is used.

The IPRM can identify missing relationships or concepts that are not represented in existing ontologies, highlighting gaps in current knowledge organization. This process of phenotyping-characterizing and contextualizing concepts as they occur in and across documents-enables the IPRM to represent knowledge as an ecosystem of concepts, rather than as isolated or randomly associated entities. As a result, the non-random co-occurrence of concepts forms identifiable patterns (phenotypes) that capture practical, real-world knowledge. The IPRM framework leverages these patterns to build a network of relationships, facilitating navigation across disparate data sources and revealing both known and previously unrecognized connections. In law enforcement, cases are built to determine the identity of an unknown perpetrator during detective work. In a medical analogy, sufficient symptoms, physical findings, and test results can uniquely determine a diagnosis and rule out everything else. Specifically, the IPRM can:
a. predict missing data,
b. provide clinical decision support—most likely diagnosis, differential diagnosis,
c. predict best next steps toward a desired outcome without having complete knowledge
d. predict the desired workflow within a complex IT application, and
e. detect most likely relationship pathways between disparate concepts

### 22. Path Finding Methods

The IPRM system can create different IPRM networks as distinct phenotype reference models, with touchpoints and connections between them that form crossover points. These crossover points allow combining and integrating the distinct phenotype reference models into a single IPRM network, which then permits computational efficiency while transitioning between concepts from very different disciplines along different paths. The purpose of finding different paths between two concepts that are not directly connected to each other is to generate additional related concepts that may be relevant to an inquiry or decision. The use cases described further below illustrate why this is useful. Note that the various path methods defined here are not guaranteed to generate unique answers; that is, more than one path may be a solution to the method used.

The Dijkstra algorithm is one method used in the IPRM system to find the most efficient path between two unconnected concepts. The Dijkstra algorithm is a fast and efficient method for computing the minimum distance and is commonly used by map navigation applications. Technically, it computes the shortest path between concepts in a weighted network, but the weights can represent either distance (for the shortest path), time (yielding the fastest path), or any other value that needs to be optimized. The Dijkstra algorithm is easily adapted to on-the-fly re-computation as circumstances change, and therefore is useful in navigating the dynamic networks of an IPRM.

While the Dijkstra path finds the minimum distance (which, for us, is the inverse weight) between two unconnected concepts, the simplest path is the one with the fewest concepts in between. This is easily computed by ignoring the weights in the IPRM and assigning a distance of 1 to every edge. The computed Dijkstra path then becomes the one with the fewest legs, i.e., the path with the fewest concepts between the origin and destination.

Hub-and-spoke routing computes the path that minimizes the number of concepts while maximizing the centrality of those concepts. There are a number of published algorithms that accomplish this dual-factor optimization because this is a common routing approach for internet information.

Hub-and-spoke routing can be easily accomplished with the Dijkstra algorithm alone. The technique is to add a “distance” to each concept along the path, equal to the inverse of that concept's centrality. Then the total path is the sum of the edge distances (defined above as 1/w) and the sum of the concepts' distances (1/C), which the Dijkstra algorithm easily minimizes.

Anti-centralized routing avoids the big hubs. This path minimizes the number of concepts and, at the same time, reduces the centrality of those concepts. This is not a common dual-factor optimization, but it is useful in the IPRM when the need is to explore nearby concepts that are not common. It's a method for discovering “sneak circuits,” where two concepts may be related by something uncommon or unexpected, i.e., something potentially anomalous.

Again, the Dijkstra algorithm can compute this path. Here, the concepts along the path contribute a “distance,” but this time it's their centrality C itself, with no further manipulation. As with the hub method, the total path is minimized using Dijkstra, producing an efficient path that uses only “byways.”

Hybrid and circuit paths are to hybridize path methods, either by combining them linearly, moving from an origin concept to a destination concept while pivoting between methods at some interim concept, or by combining two methods into a complete circuit, moving from an origin concept to a destination by one method and then returning to the origin by a different method.

The point of all path methods is to generate a set of related concepts to suggest to users when searching for relationships that may be indirect or obscure, but nonetheless potentially critical to be aware of.

Although most of the utility of an IPRM lies in finding a cluster of closely related concepts, occasionally the path between two concepts is of interest. This use case arises when there is a question about how two concepts might be connected when they are not already directly connected to one another. The example above regarding orthogonal datasets illustrates how such a question could arise, namely, it's often in the coincidence of very different concepts (e.g., rainfall and IV fluids) that provokes a suspicion that there must be a connection somehow. Any of the pathway methods, including hybrids, can find efficient pathways and demonstrate how distant concepts within an IPRM are connected, so end users can determine whether any of those suggested pathways is relevant to their inquiry.

For example, a scenario can require determining what's missing from a cluster (that is, what's highly connected to a set of seed concepts). While the IPRM might predict a best next step given a set of circumstances, garners may be unaware of that step and respond by introducing an unexpected or suboptimal element, which in turn would reset the seed concepts and force the IPRM to generate a new ranked list of next steps. If the game is designed to leverage fuzzy sets or probabilistic clusters, or to use modifiers as algorithms, even more variability can be introduced, leading to multiple variations of the scenario.

### 23. Use Cases of IPRM

The IPRM system can be used in various environments to identify recurring patterns (i.e., phenotypes) of what works best and to understand how the best things work together. Treating understanding of how the best things work as a language in a field of endeavor, the IPRM system can serve as a practical guide for applying recurring solutions to common problems in the field. For example, an IPRM can be built from healthcare documents, constructing a pattern language for healthcare providers distinct from and complementary to traditional medical education. An IPRM for healthcare can provide phenotypic patterns of what works and how it fits together, built entirely on how healthcare is actually practiced. Such an IPRM might be a good educational tool to supplement residency, where all the book knowledge from medical school is turned sideways and connected laterally.

As another example, in medicine, many concepts have important temporal elements, such as a “rising” temperature or “worsening” abdominal pain. An IPRM does not inherently capture temporal relationships because the edges in the network are undirected (i.e., an edge represents the simple co-occurrence of two concepts within a document, without any notion of which concept takes precedence). However, an IPRM's readability and editability via CRUD operations permit the addition of specialized concepts that capture temporal elements, so new concepts such as “rising fever” or “falling fever” might be inserted alongside an existing temporally neutral “fever” concept within the IPRM if those temporal concepts are particularly relevant to a cluster of symptoms. Such concepts could remain a permanent part of an IPRM if they are found to be relevant across multiple circumstances, or they might simply serve their tailored purpose and be deleted thereafter.

Alternatively, in the above example, one might add “rising” as a modifier (that is, as metadata) to an existing “fever” concept, or, in some other circumstance, add a positive or negative valence to a concept that is specifically known to be present or absent, respectively. Generally, metadata forms powerful secondary layers of relationships between concepts that can inform other means of ranking relationships and suggest when a type of concept might be missing from an otherwise identified cluster (see 6. Unknown unknowns, below).

The IPRM supports the tedious process of manual mapping between systems through several features. For example, mapping datasets to the IPRM networks allows multiple datasets to share data without having to be individually mapped to one another, which would otherwise quickly lead to a combinatorial explosion as more datasets are combined.

The IPRM can be used to detect what content is expected in a given context, exposing when data are incomplete when some expected type of content is missing, thereby supporting data cleaning for interoperability.

The IPRM system can help predict data architecture from the content itself. For example, in medicine, if two data fields contain many specific medications, one can infer that both are medication lists, even if the fields have idiosyncratic names and no other obvious architectural relationship.

The IPRM system can also map concepts to their respective ontologies and reveal which other data should be nearby, without requiring knowledge of how they are organized in the system. This can help manual mapping by showing users where to look for different data elements across a complex system, or it can bypass the human process altogether and simply find the expected types of data wherever they occur. This feature is a direct byproduct of document centricity.

All IPRM use cases rely on the identification of clusters of related concepts using attributes. As described above, various clustering methods can be used to leverage different relationships and approaches from available angles. There are many circumstances where collecting observations, complaints, or symptoms from an entity or system is needed to determine a diagnosis, which in turn is the precursor to formulating a response plan. Domain-specific IPRMs, as well as cross-domain models, can be used to translate technical patterns into named entities. Below is a sample of instances for this use case:
a. Automotive technicians: Diagnose car troubles and mechanical issues to determine necessary repairs.
b. IT professionals: Troubleshoot and diagnose problems with computer networks, hardware, and software systems.
c. Electricians: Identify and diagnose electrical issues in buildings and systems.
d. HVAC technicians: Diagnose problems with heating, ventilation, and air conditioning systems.
e. Plumbers: Identify and diagnose plumbing issues in residential and commercial buildings.
f. Appliance repair technicians: Diagnose malfunctions in household appliances.
g. Aircraft mechanics: Diagnose issues within aircraft systems and components.
h. Industrial mechanics: Troubleshoot and diagnose problems with manufacturing equipment and machinery.
i. Environmental scientists: Diagnose complex environmental issues, their causes, and sequelae.
j. Forensic scientists: Analyze evidence to diagnose causes of crimes or accidents.
k. Quality assurance professionals: Identify and diagnose issues in manufacturing processes or product quality.
l. Agricultural specialists: Diagnose crop diseases and pest problems.
m. Building inspectors: Identify and diagnose structural or safety issues in buildings.
n. Cybersecurity professionals: Identify and diagnose security threats and vulnerabilities in computer systems.

### 24. Metathesaurus Across Ontologies

Concepts within IPRM networks carry (and can dynamically accrue) attributes such as unique identifiers of where those concepts appear in external formal ontologies. As stated above, the IPRM system indexes concepts to formal ontologies and controlled vocabularies in its information pipeline. As a result, the IPRM system creates a thesaurus of synonyms between IPRM concepts and the formal ontologies. The IPRM networks can also capture cross-domain relationships that are not necessarily synonyms per se, but rather specific meaningful relationships that are demonstrated to exist in day-to-day usage. This means the IPRM can be used as a “metathesaurus,” providing a bridge between ontologies that is relevant to everyday use but is not necessarily discernable from word matching or any other information intrinsic to the structures of the ontologies.

For example, the most common medication used in the treatment of type 2 diabetes is metformin, and the most common lab ordered for type 2 diabetes is the hemoglobin A1c. Diabetes is represented in the SNOMED ontology as a disorder of carbohydrate metabolism and of the endocrine system. The medication metformin is represented in the RxNorm ontology as a type of biguanide, a subclass of nitrogen compounds. The lab test hemoglobin A1c is represented in the LOINC ontology as a kind of hematology protein test. Since these three concepts—the diagnosis of type 2 diabetes, the medication metformin, and the lab test hemoglobin A1c—so commonly appear together in patient visit documents where the diagnosis is type 2 diabetes, they will emerge in the IPRM as highly ranked co-occurrences. This relates the three concepts intimately and bridges the three separate ontologies in which they appear, so that we might now discern a relationship between carbohydrate metabolism, biguanides, and red blood cell proteins in a way that is meaningful but not otherwise obvious. Ontologies might not speak the same language or even subscribe to the same mental constructs, yet they may still be revealed by the metathesaurus to have close semantic relationships.

### 25. Data Interoperability Between Orthogonal Datasets

Orthogonality between datasets means there are no data elements in one dataset that align with any elements in the other. Any notion of interoperability in this context may seem moot. However, by expanding what constitutes interoperability to include behavioral or functional interoperability, an IPRM can create the pathways.

For example, a weather dataset might include temperature, atmospheric pressure, rainfall, and geography. Meanwhile, a hospital's dataset may include diagnoses, medications, lab tests, and so on. Normally, there would be no attempt to create interoperability between the weather and hospital data; however, the multidisciplinary relationships that an IPRM captures can easily expose the real connections between how the data from one domain interacts with the data from others. So when Houston receives 3 feet of rain from Hurricane Harvey, drinking water gets contaminated with sewage, a hospital sees an increase in cholera diagnoses, the hospital seeks a steady supply of sterile IV saline, and the hurricane also interrupts Puerto Rico's manufacturing plants for IV fluids, an IPRM knits that whole story together and directly relates those very different data elements to one another.

This multi-disciplinary interoperability is behavioral or functional and arises due to focusing on how ecosystems of data work, rather than focusing on the data elements themselves. To my knowledge, there is no other method that can bridge completely orthogonal datasets.

### 26. Document-Centric Interoperability

Because the document is the IPRM's core transactional unit, the IPRM naturally supports interoperability among documents. This is a consequence of both the far-reaching connections among concepts, which remain linked to their source documents, and the fact that a concept-modified TFIDF provides the semantic gist of a document. Document-centricity yields a human-centric understanding of relatedness and provides a ready path when you have two documents and want to know how to combine them.

### 27. Frequentist-Bayesian Hybridization

When monitoring data for a highly improbable (rare) event, it is possible to detect a signal that suggests the event might have occurred, even though the event remains highly improbable, though slightly less so given the detectable signal. In such a scenario, it remains much more likely that the data signal is a false alarm (a false positive) because the event is rare to begin with, and signals in data are always a bit noisy.

A probabilistic model called a Bayesian network can enhance the predictive value of a signal by combining it with other signals from other datasets. In a way, a Bayesian network uses the presence of multiple independent signals to triangulate on an event; when each of those datasets yields a positive signal around the same time or place, the likelihood that those signals are converging on a true-positive increases dramatically.

When we seeded a query to the children's literature IPRM with the concepts “food,” “should,” “must,” and “home,” we found that “mother” was the strongest connection to the seed set. If we were to back that process up a bit and seed the query with just the “food” concept, the “mother” concept would be among the possibilities, but it would still be very unlikely (a rare event, perhaps). If we were to then try seeding with both “food” and “should,” “mother” would move up the rankings, and the total list of possibilities would shrink. A third seed concept would further increase the likelihood that “mother” is our concept, and all four seeds would push “mother” to the top of the list of possibilities. While there are mathematical ways to explain why it happens, it boils down to each seed concept stripping away false positives until only the true positives remain, or, at a minimum, the true positives have fewer false positives to compete with in the rankings.

The process of determining a differential diagnosis, and ultimately the final diagnosis, in medical care relies on Bayesian network thinking in the same way, by reducing false positives (noise) by adding additional concepts, such as symptoms or lab results, to clarify what is most likely. An IPRM does this process—whether for children's stories or for medical diagnoses—as a direct byproduct of its structure.

An IPRM might therefore be called a frequentist's implementation of a Bayesian network, or a frequentist-Bayesian hybridization, since it performs a Bayesian network computation by leveraging a frequentist's sampling methods. Like all frequentists, the data collected into and represented within the IPRM—the network of concepts and the weighted connections between them—are the result of repeated sampling across documents, and the weights are quite literally the current frequency (count) of the co-occurrences.

### 28. Patient Phenotyping

Patient phenotyping is what medical informatics has been doing for years; the IPRM offers a more general approach. Individual patients are represented as attributes derived from medical records, and, like most attributes, they are modeled as concepts in an IPRM network. When you specify the patient features you are looking for, for example, men over 50 with no history of heart disease, as seed concepts, and then constrain the resulting set to concepts whose TUI is that of a patient, you have a patient group that meets your criteria.

To phenotype a specific patient completely, the easiest way is to start with the source documents and combine all documents belonging to that patient into a single super-document and then process the phenotyping for that super-document.

### 29. Social Networks

People can become concepts on an IPRM network based on the frequency of their mentions in documents. This is not the same as the explicit network of ‘friends’ on social media; rather, it captures how people intersect in the real world. For example, an academic paper has mentions of the authors of the paper itself, plus the authors of the citations. All these people form a social network around this paper, and each of them will be connected to a larger network of concepts that, in turn, connect still more people. This kind of social network tracking is particularly useful in law enforcement investigations.

### 30. Unknown Knowns

The IPRM system's primary function is to find unknown knowns. That is, the IPRM system captures an extensive ecosystem of information, so if information has been made known through document processing, the IPRM system has captured it. When an end user searches for information, they are trying to find something they don't know in a network of known things—unknown knowns. Because of the extensive network of concepts and connections, finding an unknown is more efficient by leveraging what is known about it. What is known seeds the search and reduces the search space to manageable suggestions. In this way, finding unknown knowns is a matter of finding what's missing from a pattern.

### 31. Determine Medical Diagnosis

In healthcare, collecting observations, complaints, symptoms, and similar information from a patient to determine a diagnosis is the first step in formulating a clinical plan. An IPRM is designed to help identify a ranked list of possible diagnoses. The ranked list (the “differential diagnosis”) is most commonly derived from fully connected clustering, as in the example used for children's literature, but limiting the type (TUI) of concept to diagnoses. Any clustering method can assist, and fuzzy sets in particular might help generate unusual possibilities that would normally be overlooked.

### 32. Determine Other Elements of Medical Care

Medications, consultations, and orders of any kind are types of medical data that can be provided as ranked suggestions by the IPRM. Furthermore, many of these elements, which might rightfully belong to the plan of care, are more precisely predicted once a diagnosis has been added to a seed group of concepts. In this regard, an IPRM is a form of clinical decision support built not on rule-based logic but on the actual patterns of practice, as captured in documents in real time, where the reason for any suggested clinical guidance is immediately discernable and traceable to example supporting documents.

Although adding a diagnosis improves the precision of prediction, it is not necessary for the IPRM to generate ranked lists of medications or lab studies. The IPRM thus formalizes a common situation in medical practice: proceeding to the next best step in therapy even when there is uncertainty about what's going on. In short, an IPRM can help build an optimal clinical plan in the absence of a diagnosis.

### 33. Complex Modeling

An IPRM can serve as the substrate for agent-based modeling (ABM) and other numerical methods for solving sets of simultaneous equations. This is achieved by a small variation to modifiers: the second TUI in a modifier remains ‘how to use the number,’ but instead of a category such as “degree of certainty,” it becomes any logical or mathematical algorithm, with simpler being better, so the algorithm might be amenable to GPU parallel processing. IPRM's modifier element can be an active agent within the larger machine-learning environment. The IPRM can be used as a novel emulation of deep learning, but instead of the feed-forward/back propagation directionality of a neural network, there is undirected lateral communication and local optimization across concepts. In essence, the IPRM becomes a numerical method for solving simultaneous equations. Such a capability is agent-based, in which the IPRM system equilibrates entirely through local interactions and carries extensive information about the environment in which the agents are active, including very long-range connections. The capability enables modeling the IPRM system as a finite element analysis in structural engineering or even the management of a live nuclear power plant. As with other agent-based methods, the model remains reasonably interpretable for end users. The many elements of an IPRM network can create a web in which concepts form a multidimensional tiling, and the edges define how the tiles touch. When an IPRM modifier is used with a self-updating algorithm, a distinction arises between the IPRM and the way most agent-based models are constructed. Specifically, the IPRM geometry allows information to flow from far beyond the local neighborhood.

This feature enables modeling of complex and dynamic systems, ranging from finite element analysis of dynamic loading to multi-body problems of planetary motion. As mentioned above, this methodology creates a computational overhead that may or may not be amenable to parallel processing on GPUs. Although these extensions of an IPRM diverge from its basic simplicity, the use of undirected networks for computation stands in stark contrast to the directed networks of the deep learning models being built today, suggesting exciting implications that remain to be fully explored.

### 34. Known Unknowns

The IPRM system invites browsing and exploration, posing intuitive questions that enable novel observations. In this way, IPRM can be used to reveal known unknowns through human-machine collaboration. One of the differences between an IPRM and what an LLM can do is that a human with external knowledge can insert the knowledge that something is missing into an IPRM. For known unknowns, this amounts to adding a placeholder in the IPRM—a question mark concept of sorts—to allow connections to be attached or to emerge during processing, until sufficient information is known and the question can be resolved.

A specific use case for managing known unknowns is using the IPRM system to computerize the pushpin and yarn evidence boards used in investigations, computing likelihoods, pathways, and related clusters, all in the form of suggestions to support the end-user's thinking. For example, in law enforcement, an IPRM network can serve as an evidence board or Anacapa chart, where the equivalent of a big question mark can be temporarily added to a cluster of related pieces of evidence already defined within the IPRM system. The question mark serves as a placeholder concept in the law enforcement IPRM network until the named entity is more fully identified and the question itself can be removed.

### 35. Unknown Unknowns

Another class of use cases for the IPRM system is detecting unknown unknowns, that is, the presence of something significant that is not known to be there and that the IPRM hasn't previously characterized within its network. For example, the IPRM system can be used for anomaly detection based on phenotypes in an IPRM network, where patterns of concept nodes are reinforced over time as more documents are processed. One clue that something is influencing the IPRM network, even when its presence is not represented in that IPRM network, is when an established pattern begins to show variation that may indicate the presence of something new or the absence of something previously present. Small changes in edge conditions are usually noise in a noisy world, but occasionally they offer the only hint about something unknown and unexpected when some features make the changes less likely to be just noise.

The following examples illustrate the existence of unknown unknowns in IPRM networks:
a. a noticeable time or location clustering for changes,
b. a change in a particular type (TUI) of concept in the pattern, such as, for example, a new inconsistency among diagnosis types of concepts that are associated with a cluster of symptoms;
c. a type of concept (TUI) falls out altogether, for example, when a familiar set of symptoms occurs in recent documents, but none have a diagnosis co-occurring.
d. appearance of something new and peculiar within a cluster that never had that element before
e. If multiple clusters show similar variations at the same time, this could indicate that a signal is being detected independently across types and domains.

The IPRM system can automatically detect the above-mentioned unknown unknown example. If the flags, taken together, raise sufficient suspicion that something novel may be occurring, or if the risk of ignoring a potential novel event is too high, the first step for the end-user is to manually insert a question mark concept and connect it to the concepts where the aberrant behavior is occurring. It then becomes a known unknown and can accrue features until it has been either fully characterized or dismissed.

### 36. IPRM Capabilities

Based on the foregoing specification, the IPRM uses a technical data-integration architecture grounded in graph theory, co-occurrence analysis, and scalable computation, which is substantively stronger than most knowledge-graph or “AI ontology.” The IPRM computes and outputs candidate entities/clusters/pathways as suggestions, where the human remains the decision-maker. The IPRM can generate a ranked list of concept nodes, such as candidate diagnosis concept nodes, by applying fully connected clustering over a graph of co-occurrence relationships, that can optionally be constrained by a type identifier, such as a diagnosis-type tag. The IPRM The IPRM enables traversing a weighted graph to identify and output additional concept nodes connected to query concept nodes, where the additional nodes were not included in the query. The IPRM can compute alternative paths between concept nodes in different clusters and outputs intermediate concept nodes as explanatory connectors. The IPRM can detect deviations in learned co-occurrence/edge-weight patterns over time and output an anomaly indicator or candidate missing concept placeholder. The IPRM can compute a likelihood value associated with a candidate pathway/cluster based on edge weights, centrality, or probabilistic modifiers. The IPRM can detect statistically significant variations in edge conditions and generate an output indicating a likely missing concept node, optionally enabling insertion of a placeholder node. The IPRM can compute, for each document, a score for extracted concepts based on within-document frequency and across-corpus frequency and use the scores to infer document adjacency.

IPRM solves the technical challenge, such as data “silos” and lack of interoperability. Specifically, IPRM uses unique identifiers and weighted edge computations to solve the technical problem of orthogonal datasets (datasets with no shared elements) by mapping behavioral patterns rather than just schema matching. This feature of IPRM enables new capabilities enables computations that were previously unavailable, such as bridging completely orthogonal datasets (e.g., weather and hospital data). Moreover, IPRM provides efficiency by reducing computational overhead or increasing processing speed compared to standard methods by using power-law reduction in search space, which allows the system to function with fewer memory or CPU resources than conventional models. Moreover, the specific combination of document-centricity, lateral weighted edges, and incremental human editing via CRUD operations is a non-conventional arrangement. These elements interact to solve a problem necessarily rooted in computer technology, such as the combinatorial complexity of mapping thousands of disparate data tables in a flexible manner using identifiers and CRUD operations, which allows the system to be human edited without causing “non-linear ripple effects,” which is a distinct advantage over the rigid training cycles of LLMs. IPRM can track millions of connections (edges) between hundreds of thousands of concepts across disparate domains—a scale impossible for human cognition. In practice, IPRM provides clinical decision support by generating a “differential diagnosis” based on actual practice patterns rather than just rule-based logic. IPRM can be used for anomaly detection by detecting variations in established phenotypes beneficial, for example, in evidence board automation.

1. A computer-implemented system for constructing and maintaining an integrated reference model, comprising:
a computing layer comprising one or more processors;
a database layer interfacing with the computing layer comprising a database that stores a plurality of documents, each document associated with a document unique identifier (DUI);
a concept extraction module configured to:
process each document to identify a plurality of concepts; and
assign a concept unique identifier (CUI) to each identified concept within a document, wherein the database associates each CUI with the DUI of the document where the corresponding document was found;
a concept contextualization module configured to associates each concept with contextual attributes as metadata, wherein the database associates the metadata associated with each concept with the CUI of the concept;
a network construction module configured to:
generate a network of concept nodes, wherein each concept node represents a concept identified with a corresponding CUI;
generate edges between concept nodes based on co-occurrence of concept pairs within documents, wherein each edge assigned an edge unique identifier (EUI) that represents a relationship between two concept nodes each identified by a corresponding CUI, where in the database associates the EUI with the CUIs of the two related concept;
determine a weight for each edge identified by an EUI based on frequency of co-occurrence, where in the database associates the EUI with the corresponding weight of the edge;
a clustering module that implements a clustering algorithm to identify clusters comprising sets of closely related concept nodes;
a path finding module that implements a path finding algorithm that identifies relationships between clusters or relationship between two concept nodes that are not directly connected to each other by an edge;
a query processing module configured to:
receive a user query comprising one or more concepts;
traverse the network to identify related concept nodes and clusters using at least one of a clustering or a path-finding algorithm,
output a response comprising data relevant to the query, including concept nodes not explicitly included in the query, wherein the system is configured to incrementally update the network in real time as new documents are processed, and to allow user editing of concept nodes, edges, and metadata via create, read, update, and delete (CRUD) operations.

2. The system of claim 1, wherein the clustering algorithm is selected from the group consisting of: fully connected clustering, Nash equilibrium clustering, attribute adjacency clustering, and fuzzy set clustering.

3. The system of claim 1, wherein the path-finding algorithm is selected from the group consisting of: Dijkstra's algorithm, hub-and-spoke routing, anti-centralized routing, and hybrid routing.

4. The system of claim 1, wherein the concept nodes are indexed to external ontologies.

5. The system of claim 1, wherein contextual attributes include classifications of concepts based on types identified by type unique identifiers (TUIs).

6. The system of claim 1, wherein a ranked list of related concepts or clusters is generated in response to a user query, based on edge weights or node centrality.

7. The system of claim 1, wherein a user interface module allows manual insertion of placeholder concept nodes representing unknown or missing concepts.

8. The system of claim 7, wherein the network is updated when unknown or missing concepts become known.

9. The system of claim 1, wherein traversing the network comprises computing at least one indirect path between a first cluster of concept nodes and a second cluster of concept nodes and outputting intermediate concept nodes along the indirect path as explanatory connectors.

10. A computer-implemented system for constructing and maintaining an integrated reference model, comprising:
a computing layer comprising one or more processors;
a database layer interfacing with the computing layer comprising a database that stores a plurality of documents, each document associated with a document unique identifier (DUI);
a concept extraction module configured to:
process each document to identify a plurality of concepts; and
assign a concept unique identifier (CUI) to each identified concept within a document, wherein the database associates each CUI with the DUI of the document where the corresponding document was found;
a network construction module configured to:
generate a network of concept nodes, wherein each concept node represents a concept identified with a corresponding CUI;
generate edges between concept nodes based on co-occurrence of concept pairs within documents, wherein each edge assigned an edge unique identifier (EUI) that represents a relationship between two concept nodes each identified by a corresponding CUI, where in the database associates the EUI with the CUIs of the two related concept;
determine a weight for each edge identified by an EUI based on frequency of co-occurrence, where in the database associates the EUI with the corresponding weight of the edge;
a query processing module configured to:
receive a user query comprising a set of two or more seed concepts represented by seed concept nodes;
identify, within the network, a set of candidate concept nodes that are fully connected to all seed concept nodes;
apply a power law reduction algorithm to iteratively reduce the search space of candidate concept nodes as the number of seed concept nodes increases, wherein the search space is reduced according to a power law function such that the addition of each seed concept node results in a non-linear, sublinear decrease in the number of candidate concept nodes;
rank the candidate concept nodes based on aggregate edge weights and output a response comprising the ranked set of candidate concept nodes relevant to the user query; wherein the system is configured to incrementally update the network in real time as new documents are processed, and to allow user editing of concept nodes, edges, and metadata via create, read, update, and delete (CRUD) operations.

11. The system of claim 10, wherein the power law reduction algorithm comprises performing a series of set intersections among the sets of concept nodes connected to each seed concept node.

12. The system of claim 10, wherein the query processing module is further configured to display the reduced set of candidate concept nodes to a user via a graphical user interface.

13. The system of claim 10, wherein the ranking of candidate concept nodes is based on the sum of the weights of edges connecting each candidate concept node to the seed concept nodes.

14. The system of claim 10, wherein a user interface module allows the user to select additional seed concept nodes to further reduce the search space in accordance with the power law reduction algorithm.

15. The system of claim 10, wherein the power law reduction algorithm is applied to multimodal documents comprising text, images, audio, or video.

16. The system of claim 10, wherein the query processing module is further configured to display the reduced set of candidate concept nodes to a user via a graphical user interface.

17. The system of claim 10, wherein the system is further configured to apply the power law reduction algorithm in combination with a clustering algorithm selected from the group consisting of: fully connected clustering, Nash equilibrium clustering, attribute adjacency clustering, and fuzzy set clustering.

18. A computer-implemented method for constructing and maintaining an integrated reference model, comprising:
storing, in a database, a plurality of documents, each document associated with a document unique identifier (DUI);
for each document:
extracting a plurality of concepts from the document using a concept extraction algorithm;
assigning a concept unique identifier (CUI) to each extracted concept;
associating contextual attributes as metadata with each concept;
generating a network of concept nodes, each node corresponding to a CUI;
generating edges between concept nodes based on co-occurrence of concepts within documents, each edge assigned an edge unique identifier (EUI) and a weight based on frequency of co-occurrence;
receiving a user query comprising one or more concept nodes;
traversing the network to identify related concept nodes and clusters using at least one clustering or path-finding algorithm;
outputting a response comprising data relevant to the query, including concept nodes not explicitly included in the query;
incrementally updating the network in real time as new documents are processed; and
enabling user editing of concept nodes, edges, and metadata via create, read, update, and delete (CRUD) operations.

19. The system of claim 18, wherein the system is further configured to allow manual insertion of placeholder nodes representing unknown or missing concepts, and to update the network as additional information becomes available.

20. The system of claim 18, wherein traversing the network comprises computing at least one indirect path between a first cluster of concept nodes and a second cluster of concept nodes and outputting intermediate concept nodes along the indirect path as explanatory connectors.
